(19) United States
(12) Patent Application Publication
(10) Pub. No.: US 2003/0152873 A1
(43) Pub. Date: Aug. 14, 2003

(54) Fabrication method of semiconductor integrated circuit device

(76) Inventors: Yasushi Tainaka, Ome (JP); Yasuo Sonobe, Kokubunji (JP); Mikinori Kawaji, Hino (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/331,663

(22) Filed: Dec. 31, 2002

(30) Foreign Application Priority Data
Feb. 14, 2002 (JP) 2002-037203

(51) Int. Cl. G03C 5/04

(52) U.S. Cl. 430/313; 430/315; 430/5; 430/322; 430/396

(57) ABSTRACT

Provided is a fabrication method of a semiconductor integrated circuit device, which comprises preparing a first mask having a plurality of openings formed in a halftone film which has been deposited over a mask substrate and has a function of reversing the phase of a transmitted light; preparing over said first mask a second mask which is made of a resist film capable of blocking an exposure light and has a resist pattern formed to expose desired opening patterns, among said plurality of opening patterns of said first mask, and a part of said halftone film around said desired opening patterns and to cover the other opening patterns; and transferring the desired patterns onto a photoresist film over a wafer by reduction projection exposure treatment with said second mask. According to the present invention, TAT and in turn, the delivery time of the semiconductor integrated circuit device can be shortened.

### BACKGROUND OF THE INVENTION

The present invention relates to a fabrication technique of a semiconductor integrated circuit device, particularly to a technique effective when applied to an exposure technique in the fabrication process of a semiconductor integrated circuit device.

An exposure step of a semiconductor integrated circuit device is a step of irradiating, through a mask, a light emitted from an exposure light source to a photoresist film over a wafer, thereby transferring desired integrated circuit patterns to a photoresist film. A mask ordinarily employed in this exposure step has an original image of integrated circuit patterns formed by light-blocking patterns and transparent patterns. The light blocking patterns of the ordinarily used mask are usually formed by a metal film such as chromium (Cr). With a recent tendency toward miniaturization of patterns in a semiconductor integrated circuit device, there is increasingly a demand for improving resolution of patterns in a photoresist film over a wafer. Under such situations, ultra-high resolution masks such as phase shift masks or OPC (Optical Proximity Correction) masks must be used. Phase shift masks are designed to modulate the phase of a transmitted light, thereby improving resolution. A halftone phase shift mask, one of the phase shift masks, is a mask having improved pattern resolution by forming a translucent film (or semi-light-shielding film) having a light transmittance of about 4 to 6% over a mask substrate, thereby reversing the phase by 180 degree.

In Japanese Patent Laid-Open No. Hei 9(1997)-211837, disclosed is a mask having, disposed on a halftone phase shifter, patterns of a photoresist film which has been carbonized to have improved light shielding property. In Japanese Patent Laid-Open No. Hei 6(1994)-347994, disclosed is a technique of selectively forming a light shielding body in a defect region adjacent to a light transmitting region disposed in a semi light shielding region of a halftone phase shift mask. In Japanese Patent Laid-Open No. Hei 9(1997)-80741, disclosed is a technique of forming a light shielding body in the void defect region of a mask. In Japanese Patent Laid-Open No. Hei 5(1993)-289037, disclosed is a technique of constituting light shielding patterns on a mask substrate by a resist film based on the fact that the transmittance of an ArF excimer laser light through a conventional electron beam sensitive resist film or photosensitive resist film can be controlled to 0%.

### SUMMARY OF THE INVENTION

In recent years, with a request for improving the performances of a circuit of a semiconductor integrated circuit device, however, there has been a tendency toward an increase in the total number of masks necessary for the fabrication of one semiconductor integrated circuit device or use of a ultra-high resolution mask as described above has become inevitable to satisfy the request for miniaturization of integrated circuit patterns. This leads to an increase in the ratio of the time spent for the manufacture of masks in the total fabrication time of a semiconductor integrated circuit device, thereby extending the delivery date of the semiconductor integrated circuit device which is a counter trend against shortening of it. In particular, a halftone phase shift mask is accompanied with such a drawback that its manufacture (including an inspection step) needs more time than the manufacture of a conventional mask.

An object of the present invention is therefore to provide a technique to shorten TAT (Turn About Time) of a semiconductor integrated circuit device.

The above-described and the other objects and novel features of the present invention will be apparent from the description herein and accompanying drawings.

Of the inventions disclosed by the present application, the typical ones will next be described briefly.

In one aspect of the present invention, there is thus provided a fabrication method of a semiconductor integrated circuit device, which comprises forming desired patterns of the semiconductor integrated circuit device by reduction projection exposure treatment using a mask formed by selectively leaving desired opening patterns, among a plurality of opening patterns formed in a halftone film for reversing the phase of a transmitted light, by using patterns made of a resist film capable of shielding an exposure light.

In another aspect of the present invention, there is also provided a fabrication method of a semiconductor integrated circuit device, which comprises preparing, in a predetermined region of a halftone film deposited over a mask substrate, a first mask having a plurality of opening patterns for the formation of hole patterns at all the lattice intersections of an interconnect channel; preparing a second mask having circuit forming opening patterns, which have been selected from the plurality of opening patterns by the formation of patterns made of a resist film capable of shielding an exposure light; and transferring desired hole patterns to a photoresist film over a wafer by reduction projection exposure treatment using the second mask.

### BRIEF DESCRIPTION OF THE DRAWINGS

FIG. 1 is an overall plan view of a semiconductor chip having, formed thereon, a semiconductor integrated circuit device according to one embodiment of the present invention;

FIG. 2 is an enlarged fragmentary plan view illustrating one example of an internal circuit region in FIG. 1;

FIG. 3 is a cross-sectional view taken along a line X1-X1 of FIG. 2;

FIG. 4 is an enlarged fragmentary plan view illustrating one example of an internal circuit region in FIG. 1;

FIG. 5 is a cross-sectional view taken along a line X2-X2 of FIG. 4;

FIG. 6 is an explanatory view of grid lines showing an interconnect channel according to a layout design;

FIG. 7 is an explanatory view illustrating one example in which hole patterns and interconnects are disposed in the interconnect channel of FIG. 6;

FIG. 8 is an explanatory view illustrating a group of primitive cells while overlapping them with grid lines showing an interconnect channel;

FIG. 9 is a production flow chart of a mask according to one embodiment of the present invention;

FIG. 10 is an overall plan view of a standard mask during the manufacturing step of the mask according to one embodiment of the present invention;

FIG. 11 is a cross-sectional view taken along a line X3-X3 of FIG. 10;

FIG. 12 is an enlarged fragmentary plan view of a region for transferring the internal circuit region of the standard mask of FIG. 10;

FIG. 13 is a cross-sectional view taken along a line X4-X4 of FIG. 12;

FIG. 14 is an overall plan view of the standard mask during the manufacturing step of the mask following the step of FIG. 10;

FIG. 15 is a cross-sectional view taken along a line X5-X5 of FIG. 14;

FIG. 16 is an enlarged fragmentary plan view of a region for transferring the internal circuit region of the standard mask of FIG. 14;

FIG. 17 is a cross-sectional view taken along a line X6-X6 of FIG. 16;

FIG. 18 is an enlarged fragmentary plan view of a standard mask which is the modification example of FIG. 17;

FIG. 19 is a cross-sectional view taken along a line X7-X7 of FIG. 18;

FIG. 20 is an explanatory view of a disposal example of opening patterns necessary in a region of a mask for transferring hole patterns of the internal circuit region;

FIG. 21 is an explanatory view of another disposal example of opening patterns necessary in a region of a mask for transferring hole patterns of the internal circuit region;

FIG. 22 is an explanatory view of one example of a hole utilizing ratio in a typical product;

FIG. 23 is an overall plan view of one example of the mask according to one embodiment of the present invention;

FIG. 24 is a cross-sectional view taken along a line X8-X8 of FIG. 23;

FIG. 25 is an enlarged fragmentary plan view of a region for transferring hole patterns of the internal circuit region of FIG. 23;

FIG. 26 is a cross-sectional view taken along a line X9-X9 of FIG. 25;

FIG. 27 is an explanatory view of the mask of FIG. 23 illustrating its effects on phase adjustment of an exposure light;

FIG. 28 is an explanatory view of light intensity distribution as a result of the effects of the mask of FIG. 23 on phase adjustment of an exposure light;

FIG. 29 is another explanatory view of light intensity distribution as a result of the effects of the mask of FIG. 23 on phase adjustment of an exposure light;

FIG. 30 is an explanatory view of disposal of resist patterns capable of shielding an exposure light in the mask of FIG. 23;

FIG. 31 is a plan view of a region of the standard mask upon pattern transfer at the same position as illustrated in FIG. 25;

FIG. 32 is a cross-sectional view taken along a line X10-X10 of FIG. 31;

FIG. 33 is a plan view of a region of the mask after development step of FIG. 9 at the same position as illustrated in FIG. 25;

FIG. 34 is a cross-sectional view taken along a line X11-X11 of FIG. 33;

FIG. 35 is an explanatory view of one example of an exposure system to be used for the fabrication method of a semiconductor device according to one embodiment of the present invention;

FIG. 36 is an explanatory view of exposure treatment of FIG. 35;

FIG. 37 is an enlarged fragmentary cross-sectional view of the wafer upon treatment of FIG. 36;

FIG. 38 is a fragmentary cross-sectional view of the wafer after the development step following FIG. 37;

FIG. 39 is an overall plan view of one example of a semiconductor chip constituting a semiconductor integrated circuit device according to another embodiment of the present invention;

FIG. 40 is an overall plan view of one example of a mask to be used upon transfer of hole patterns of the semiconductor chip of FIG. 39 to a wafer;

FIG. 41 is an overall plan view of one example of a standard mask constituting the mask of FIG. 40;

FIG. 42 is an enlarged fragmentary plan view of a mask according to a further embodiment of the present invention;

FIG. 43 is a cross-sectional view taken along a line X12-X12 of FIG. 42;

FIG. 44 is a cross-sectional view taken along a line X13-X13 of FIG. 42;

FIG. 45 is an explanatory view of OPC rules upon microfabrication of hole patterns;

FIG. 46 is an enlarged fragmentary plan view of a mask according to a still further embodiment of the present invention;

FIG. 47 is a cross-sectional view taken along a line X14-X14 of FIG. 46;

FIG. 48 is an enlarged fragmentary plan view of a standard mask according to a still further embodiment of the present invention;

FIG. 49 is an enlarged fragmentary plan view of a standard mask of FIG. 48;

FIG. 50 is an enlarged fragmentary cross-sectional view of a mask according to a still further embodiment of the present invention;

FIG. 51 is an enlarged fragmentary cross-sectional view of a mask according to a still further embodiment of the present invention;

FIG. 52 is an overall plan view of one example of a standard mask according to a still further embodiment of the present invention; and

FIG. 53 is a cross-sectional view taken along a line X15-X15 of FIG. 52.

### DETAILED DESCRIPTION OF THE PREFERRED EMBODIMENTS

Prior to describing the inventions according to the present application, the meanings of the terms used herein will be explained below.

1. The term “wafer” means a silicon single crystal substrate (semiconductor wafer or a semiconductor integrated circuit wafer; usually having a substantially circular plane), a sapphire substrate, glass substrate or another insulating, non-insulating or semiconductor substrate, or a composite substrate thereof, each used for the fabrication of a semiconductor integrated circuit device.

2. The term “device surface” means the main surface of a wafer on which device patterns corresponding to a plurality of chip regions are to be formed by photolithography.

3. Mask: a generic name of substrates on which patterns of a final size have been written. It embraces a “reticle” having patterns several times as large as those of the final size. The mask is used in an exposure system adopting a visible light, ultraviolet light or the like. It embraces a normal mask, phase shift mask and resist mask.

4. Normal mask (metal mask or chromium mask): an ordinarily used mask obtained by forming, on a transparent mask substrate, mask patterns from light shielding patterns made of a metal such as chromium (Cr) and light transmitting patterns.

5. Halftone phase shift mask: a kind of a phase shift mask having a halftone film which serves as both a shifter and a light shielding film, and has a transmittance of 1% or greater but less than 40%, and a halftone shifter whose phase shift amount relative to that of a portion having no halftone film reverses a phase of light.

6. Resist mask or resist light shielding mask: The term “resist mask” as used herein means that obtained by exposing a film composed mainly of a photosensitive resist to energy beam lithography or photolithography using an electron beam (ion beam) or light (ultraviolet light such as vacuum ultraviolet light, far ultraviolet light or near ultraviolet light, or visible light), thereby patterning on a mask substrate. As a light shielding film, it blocks all or part of ultraviolet rays such as vacuum ultraviolet ray, far ultraviolet ray and near ultraviolet ray, and visible light. Photosensitivity is an attribute of the above-described resin itself (if necessary, a light absorber or light scattering substance may be added). An emulsion mask or the like in which an additive composition such as silver halide plays a main role in photosensitivity is, in principle, outside the definition of the “resist mask” in the present invention. In other words, the “resist mask” does not exhibit desired light shielding property for the first time by development, but has already had light shielding property before development or at the time when applied on a mask substrate. It is needless to say that inclusion of various additives including such a composition is not prohibited. The resist is usually composed mainly of an organic resin, but addition of an inorganic substance is permitted.

7. In the field of a semiconductor, ultraviolet rays are classified as follows: A ray having a wavelength less than 400 nm but about 50 nm or greater is called “ultraviolet ray”, that having a wavelength of 300 nm or greater is called “near ultraviolet ray”, that having a wavelength less than 300 nm but 200 nm or greater is called “far ultraviolet ray”, and that having a wavelength less than 200 nm is called “vacuum ultraviolet ray”. It is needless to say that the main embodiments of the present application are effective even in a far ultraviolet region, by a KrF excimer laser, having a wavelength less than 250 nm but 200 nm or greater. It is also possible to apply the principle of the present invention even in a short wavelength edge region of ultraviolet rays having a wavelength less than 100 nm but 50 nm or greater and a visible short wavelength edge region of about 400 nm to about 500 nm.

8. The term “light shielding (light shielding region, light shielding film or light shielding pattern)” means that it has optical characteristics permitting transmittance of less than 40% of an exposure light irradiated to the region. Generally, one permitting transmittance of from several % to less than 30% is used. Particularly in a binary mask (or binary light shielding pattern) used as a substitute for the conventional chromium mask, the transmittance of the light shielding region is almost 0, that is, less than 1%, desirably less than 0.5%, more practically less than 0.1%. The term “transparent (transparent film or transparent region)”, on the other hand, means that it has optical characteristics permitting transmittance of 60% or greater of a light irradiated to the region. The transmittance of the transparent region is almost 100%, that is, 90% or greater, desirably 99% or greater.

9. The term “metal” in the context of a mask light shielding material means chromium, chromium oxide or a similar metal compound, in a broad sense, a metal-containing single substance, compound or composite having a light shielding action.

10. The term “resist film” means a film which is usually composed mainly of an organic solvent, a base resin and a photosensitive agent and also contains another component. By an exposure light such as ultraviolet ray or electron beam, the photosensitive agent causes a photochemical reaction and a product of the photochemical reaction or this product of the photochemical reaction as a catalyst causes a large change in a dissolution rate of the base resin in a development solution, whereby patterns are formed by exposure and development subsequent thereto. When a dissolution rate of a base resin in a development solution at an exposure portion increases, such a resist is called “posi type resist”, while a dissolution rate of a base resin in a development solution at an exposure portion decreases, such a resist is called “nega type resist”. In general, a resist film does not contain an inorganic material in its main component, but an Si-containing resist film is exceptionally embraced in this resist film. A general difference between a resist film and a photosensitive SOG (Spin On Glass) resides in that the photosensitive SOG contains, in a main component, Si—O or Si—N and this portion is made of an inorganic material. The main skeleton of the photosensitive SOG is SiO₂. Whether it is inorganic or organic is determined by that it has CH₃ or the like bonded at the terminal point thereof or not. In general, the photosensitive SOG is stable and widely used when having an organic terminal. But, either organic or inorganic is usable.

11. The term “semiconductor integrated circuit device” means not only that formed over a semiconductor or insulating substrate such as silicon wafer or sapphire substrate but also another insulating substrate, for example, glass such as TFT (Thin Film Transistor) or STN (Super Twisted Nematic) liquid crystals unless otherwise specifically indicated.

12. Hole pattern: fine pattern such as contact hole or via hole (through hole) having a two dimensional size equal to or not greater than an exposure wavelength on a wafer. In general, it is square, rectangular near square or pentagonal on a mask, but in many cases is circular on the wafer.

13. Line pattern: means a strip pattern constituting an interconnect or the like on a wafer.

14. Cell based integrated circuit: This term means an integrated circuit using a cell based designing system. It is a semicustom IC which has a circuit cell layout region designed by extracting the circuit cell from libraries as needed, enables mixture of blocks (macro cell having a high performance, or the like) with standard cells, and adopt a hierarchical design rule.

15. IP (Intellectual Property): The term “IP (intellectual property)” indicates a circuit block or a functional block which can reuse, as a design asset, a circuit functional block which has already been designed and has operation already confirmed.

16. Macrocell: The term “macrocell” means a circuit block or a functional block which has a higher function than a primitive cell and is used for predetermined purposes large in scale. The macrocell is classified into a hard macro in which a mask pattern is fixed and a soft macro in which library information is up to netlist representation and the mask pattern is formed at every design. Examples of the macrocell include standard cells (poly cells) of a fixed height that represent a small-scale logic gate; module cells such as RAM (Random Access Memory) having a regular layout structure and automatically generated by a module generator in accordance with an input parameter, ROM (Read Only Memory), PLA (Programmable Logic Array), multiplier, adder or data path; CPU (Central Processing Unit), analog cells and I/O (Input/Output) cells. In the macro cell, not only mask pattern information but also cell frame and terminal information for automatic placement and routing, and simulation information such as a function model, a logic model and a delay parameter are registered as a cell library in a design system (computer or the like). Upon simulation or the like, it can easily be called from a cell library and used in practice. Examples of the above-described RAM include DRAM (dynamic RAM), SRAM (static RAM) and FRAM (ferroelectric RAM), while those of ROM include mask ROM (MROM) and flash memory (EEPROM; electric erasable programmable ROM).

17. The term “interconnect lattice” means lines which indicate a path (interconnect channel) through which interconnects are placed and it consists of a plurality of interconnect lattice lines that mutually cross each other at right angles. There are two types of interconnect lattices, one has a boundary coinciding with the boundary of a macro cell, and the other has a boundary not coinciding therewith. The former one enables disposal of an interconnect can at the boundary of the macro cell, which facilitates wiring. The latter one can reduce a cell size, leading to a reduction in the size of a semiconductor chip.

In the below-described embodiments, a description will be made after divided in plural sections or in plural embodiments if necessary for convenience's sake. These plural sections or embodiments are not independent each other, but in a relation such that one is a modification example, details or complementary description of a part or whole of the other one unless otherwise specifically indicated.

In the below-described examples, when a reference is made to the number of elements (including the number, value, amount and range), the number of elements is not limited to a specific number but can be not greater than or less than the specific number unless otherwise specifically indicated or in the case it is principally apparent that the number is limited to the specific number.

Moreover in the below-described embodiments, it is needless to say that the constituting elements (including element steps) are not always essential unless otherwise specifically indicated or in the case where it is principally apparent that they are essential.

Similarly, in the below-described embodiments, when a reference is made to the shape or positional relationship of the constituting elements, that substantially analogous or similar to it is also embraced unless otherwise specifically indicated or in the case where it is utterly different in principle. This also applies to the above-described value and range.

In all the drawings for describing the below-described embodiments, elements having like function will be identified by like reference numerals and overlapping descriptions will be omitted.

In the drawings used in these embodiments, even a plain view is sometimes hatched to facilitate understanding of the drawing.

In the below-described embodiments, MIS•FET (Metal Insulator Semiconductor Field Effect Transistor) typical of field effect transistors will be abbreviated as MIS. A p-channel type MIS•FET and an n-channel type MIS•FET will be abbreviated as pMIS and nMIS, respectively.

The embodiments of the present invention will hereinafter be described specifically based on accompanying drawings.

(Embodiment 1)

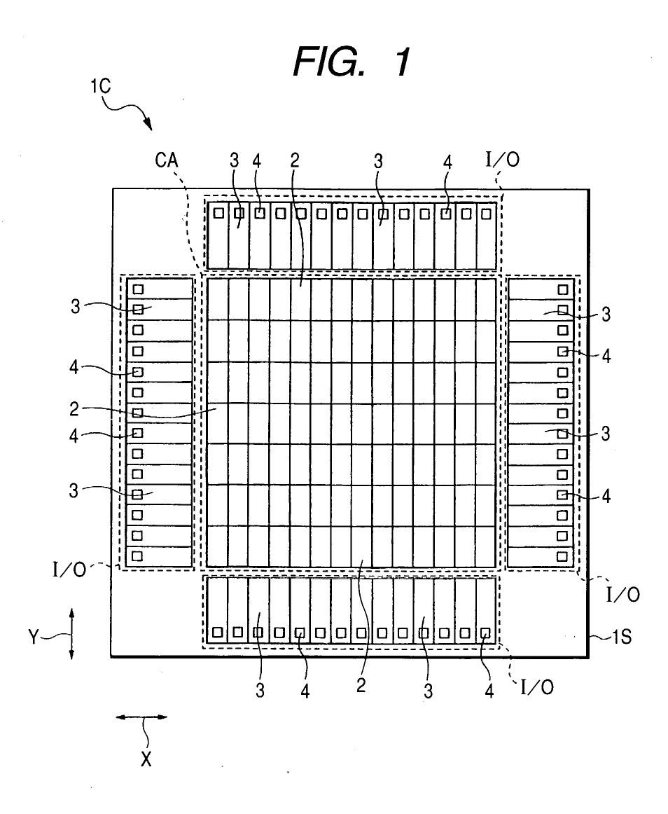

The semiconductor integrated circuit device according to Embodiment 1 is, for example, a CMIS gate array. FIG. 1 is an overall plan view of a semiconductor chip (which will hereinafter be called “chip” simply) IC constituting the semiconductor integrated circuit device. This chip IC is formed, for example, with a small silicon single crystal piece having a square plane as an element forming substrate. The internal circuit region (logic circuit region, first logic circuit region) CA at the center of the main surface (device surface) of the chip is laid, at equal distances, with a plurality of primitive cells 2 in both an X direction and Y direction extending at a right angle thereto. In short, the gate array of this Embodiment 1 is a so-called SOG (Sea Of Gate) or “channel-less type” gate array. The present invention however can be applied not only to the SOG type, but also to various types such as a conventional type in which primitive cell rows (a plurality of primitive cells 2 are disposed in parallel along the X direction) and interconnect channel regions are alternately arranged in the internal circuit region along the Y direction or a so-called complex gate array (or cell based integrated circuit) in which ROM (Read Only Memory) or RAM (Random Access Memory), as well as primitive cells 2, are arranged in the internal circuit region. The primitive cells 2 are each a unit region having one or a plurality of elements which can constitute a fundamental logic circuit (for example, OR circuit, NOR circuit, AND circuit, NAND circuit, Exclusive-OR circuit or inverter circuit).

On the main surface of the chip IC, peripheral circuit regions I/O are each disposed at the periphery of each of the four sides of the internal circuit region CA. In each of the peripheral circuit regions I/O, a plurality of input/output cells 3 and external terminals 4 are disposed along the four sides of the internal circuit region CA. This input/output cells 3 are each a unit region including an element for constituting an input/output circuit such as an input circuit, output circuit or input/output bidirectional circuit or electrostatic breakdown preventive circuit such as protective diode or protection resistor. This input circuit has a function of controlling the power supply voltage or electric signals from the outside of the chip IC to be appropriate for the internal circuit of the chip IC, while the output circuit has a function of transmitting, without causing attenuation, electric signals formed inside of the chip IC to a target electronic apparatus existing outside. The external terminal 4 is a position at which a bonding wire or bump electrode is joined and through which power supply voltage or electric signal is transferred between the inside and outside of the chip IC. The external terminal 4 is, for example, made of a conductor film having a square plane and is disposed at each of the input/output cells.

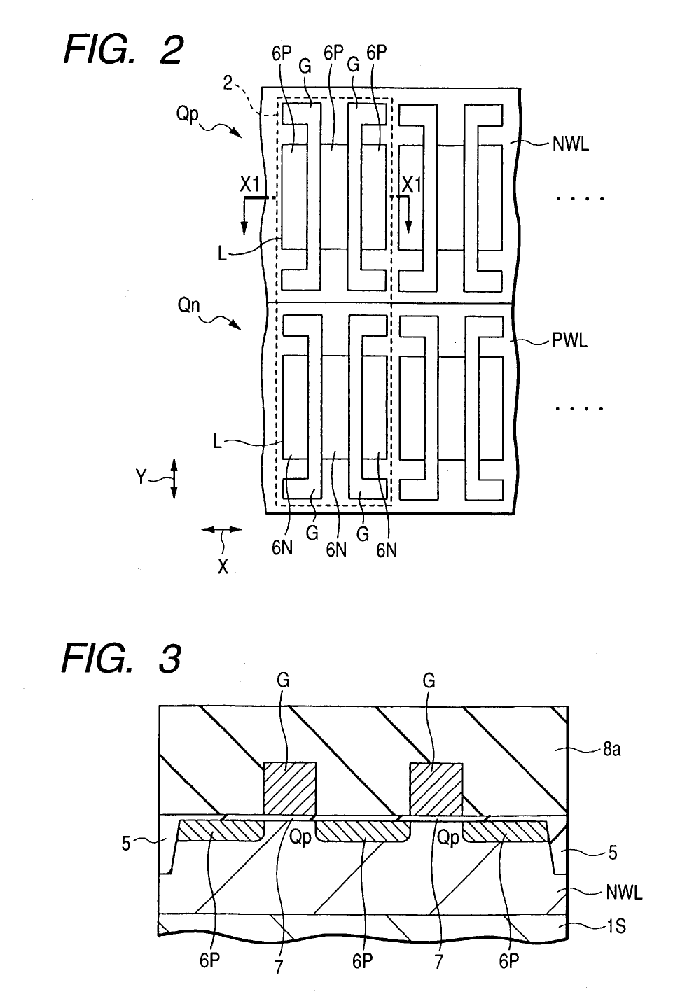

FIG. 2 illustrates one example of an enlarged fragmentary plan view of the internal circuit region CA, while FIG. 3 is a cross-sectional view taken along a line X1-X1 of FIG. 2. Here, the primitive cell 2 having two pMISQp and two nMISQn is illustrated. A CMIS (Complementary MIS) circuit can be formed from these pMISQp and nMISQn. The pMISQp and nMISQp in the primitive cell 2 each has patterns of an active region L and two strips of gate electrode G crossing thereto. Primitive cell 2 having such patterns are disposed in repetition along X and Y directions. In the internal circuit region CA of FIG. 1, strip-like patterns of n well NWL and p well PWELL extending along the X direction are alternately disposed along the Y direction. The above-described pMISQp is disposed in the n well NWL region, while the above-described nMISQn is disposed in the p well PWL. The n well NWL and p well PWL are each formed to contain a desired impurity over a desired depth starting from the main surface of the element forming substrate (which will hereinafter be called “substrate” simply) is which constitutes the chip IC. For example, phosphorous or arsenic is incorporated in the n well NWL, while boron is incorporated in the p well PWL. The substrate 1S is made of, for example, p type silicon single crystals and in the main surface of the substrate, a shallow groove or trench isolation (SGI: Shallow Groove Isolation, or STI: Shallow Trench Isolation) 5 is formed. This isolation 5 is formed by embedding an insulating film made of, for example, a silicon oxide film (SiO₂) in a groove or trench made in the thickness direction of the substrate 1S and two-dimensionally defines the above-described active region L. This isolation is not limited to a groove or trench type, but can be constituted of a field insulating film formed, for example, by the selective oxidation (LOCOS: Local Oxidation of Silicon) method.

The two pMISQp,Qp of the above-described primitive cell 2 have each p type semiconductor regions 6P for source and drain, a gate insulating film 7 and gate electrode G. The semiconductor regions 6P contains, for example, boron. Of the semiconductor regions 6P, that existing at the center of the gate electrodes G,G adjacent in parallel each other is common to two pMISQp,Qp. In order to suppress generation of hot carriers, it is possible to form the semiconductor regions 6P to have a so-called LDD (Lightly Doped Drain) structure having a low-impurity-concentration region disposed on the channel side of the MIS and a high-impurity-concentration region which is electrically connected with the low-impurity-concentration region and is disposed apart, by the width of the low-impurity-concentration region, from the channel region. In order to suppress punch-through between source and drain, it is possible to have a semiconductor region different in the conductivity type from the semiconductor region 6P at a position which is in the vicinity of the channel side edge portion of the semiconductor region 6P and has a predetermined depth from the main surface of the substrate 1S.

The two nMISQn,Qn of the above-described primitive cell 2 have each n type semiconductor regions 6N for source and drain, a gate insulating film 7 and gate electrode G. The semiconductor regions 6N contains, for example, phosphorous (P) or arsenic (As). The conductor region 6N existing at the center of the primitive cell 2 is, similar to that of pMISQp, is common to two nMISQn,Qn. Similar to pMISQp, it is possible to form the conductor regions 6N of the nMISQn to have an LDD structure or to have a p type conductor region for suppressing punch-through.

The gate insulating film 7 of each of pMISQp and nMISQn is made of, for example, a silicon oxide film. This gate insulating film 7 may alternatively be formed of an oxynitride (SiON) film. This enables suppression of the appearance of an interface state in the gate insulating film 7 and at the same time, enables a reduction in electron trap in the gate insulating film 7, thereby making it possible to improve hot carrier resistance. It further leads to an improvement in operation reliability of pMISQp and nMISQn.

The gate electrode G of each of pMISQp and nMISQn is formed by depositing, over an n type low-resistance polysilicon film, a metal film such as tungsten (W) film via a barrier metal film such as titanium nitride (TiN) or tungsten nitride (WN) (it has a so-called polymetal structure). This barrier metal film serves to prevent formation of silicide, which will otherwise occur when a tungsten film is stacked over the low-resistance polysilicon film directly, at their contact portion when it is heat treated during the preparation process. Adoption of a polymetal structure enables a reduction in the resistance of the gate electrode G, thereby improving the operation rate of the gate array. The structure of the gate electrode G is however not limited to a polymetal structure. It may be formed of, for example, a single low-resistance polysilicon film, or it may be formed to have a so-called polycide structure obtained by depositing a silicide film such as tungsten silicide over a low-resistance polysilicon film. At both ends of the gate electrode G in the lengthwise direction (at positions overlapping with the isolation region at the outer periphery of the active region L), formed are broad portions in which contact holes with upper-level interconnects are disposed. The gate electrodes of pMISQp and nMISQn are formed simultaneously to have an equal size by a patterning step using photolithography and dry etching techniques. Although no particular limitation is imposed, the gate length of the gate electrode of each of pMISQp and nMISQn is, for example, about 0.14 μm. The constitution of the primitive cell 2 is not limited to the above-described one but can be modified in various ways. It is possible to dispoSs different in gate electrode size in one primitive cell 2, for example, by disposing, in one primitive cell 2, MIS having a relatively smaller gate width and another MIS having a relatively larger gate width. By such a constitution, connection of an MIS having a small driving current (an MIS having a relatively smaller gate width) to an input of a logic circuit made of an MIS having a greater driving current (MIS having a relatively large gate width) can be actualized with a short interconnect path. Such a gate electrode G is covered with an insulating film 8a over the main surface of the substrate 1S.

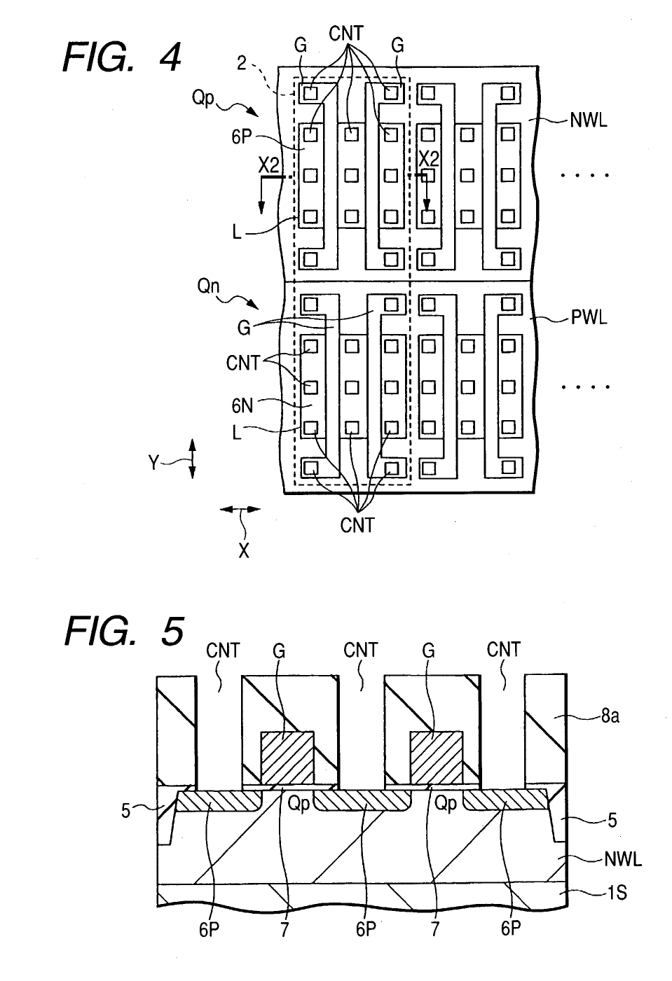

FIG. 4 illustrates one example of the arrangement of contact holes CNT, while FIG. 5 is a cross-sectional view taken along a line X2-X2 of FIG. 4. In the insulating film 8a, contact holes (hole patterns) CNT are formed. These contact holes CNT are placed so as to overlap with the broad portion of the gate electrode G and conductor regions 6P,6N. Here, all the contact holes CNT that can be connected with the primitive cell 2 are illustrated. In practice, the arrangement of the contact holes sometimes differs depending on the intended product. From the bottom of each of the contact holes CNT, a part of the broad portion of the gate electrode G or conductor regions 6P,6N is exposed. In the gate array, patterns of a plurality of primitive cells 2 are formed on the substrate 1S as a common pattern. A desired logic circuit is formed by connecting, between any adjacent two of the plurality of primitive cells 2, by hole patterns (contact holes CNT or via holes) and interconnects. In other words, it is possible to form various logic circuits by changing the layout of the hole patterns and interconnects. The hole patterns and interconnects are disposed on grid lines in the layout design.

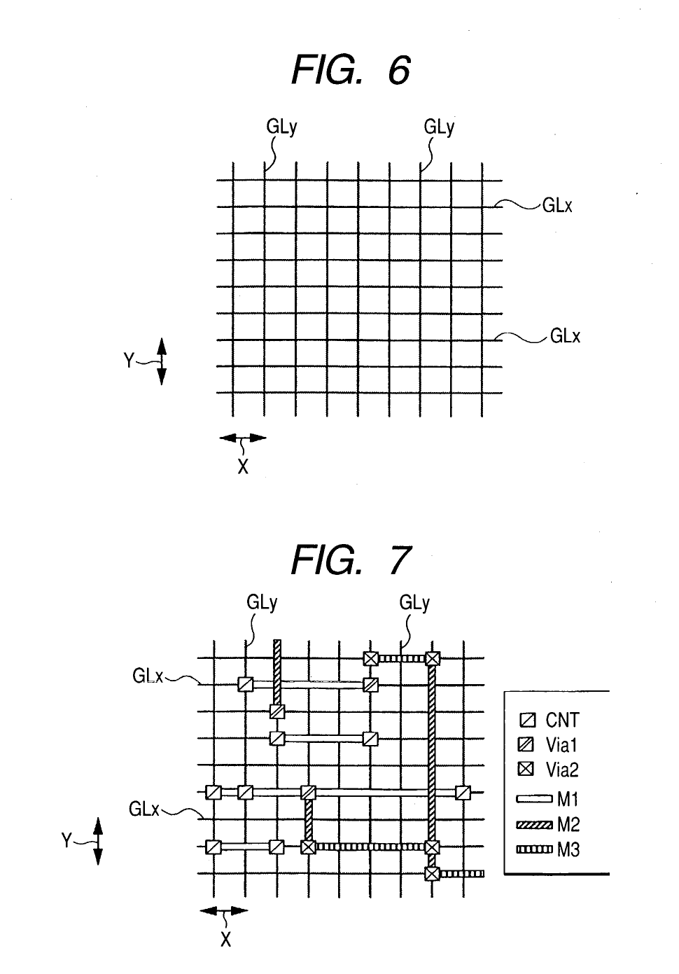

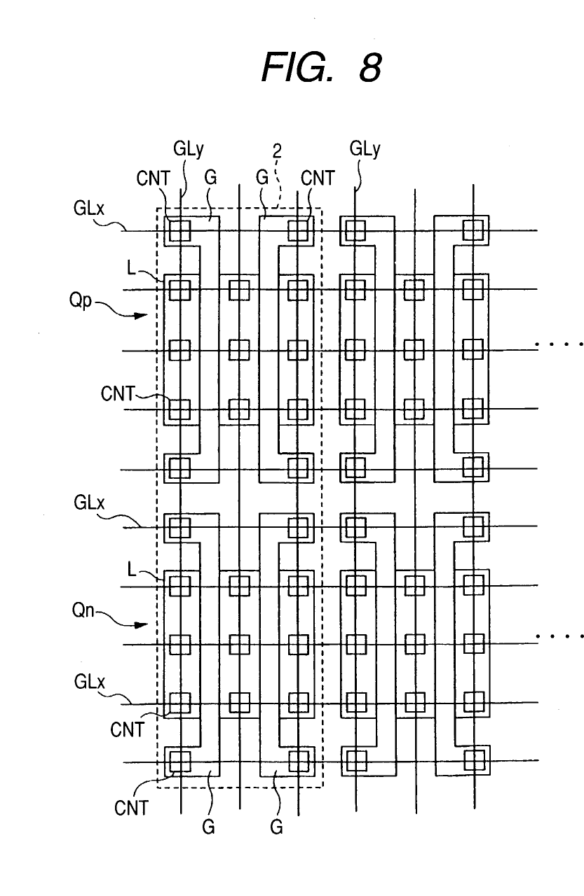

FIG. 6 is an explanatory view of grid lines GLx,Gly showing an interconnect channel in the layout design. The grid line GLx shows an interconnect channel extending in the X direction. A plurality of grid lines GLx are disposed at equal pitches along the Y direction. The grid line GLy shows an interconnect channel extending in the Y direction which crosses at a right angle to GLx. A plurality of grid lines GLy are disposed at equal pitches along the X direction. Since the primitive cells 2 are, as described above, arranged in repetition at equal distances, hole patterns and interconnects connecting them are also disposed on the grid lines GLx or grid lines Gly arranged at equal pitches. FIG. 7 illustrates one example of the arrangement of hole patterns (contact holes CNT, via holes Via 1, Via 2) and interconnects M1,M2,M3 on the interconnect channels of FIG. 6. The interconnects M1,M2,M3 are disposed along the grid lines GLx,Gly, while contact holes CNT and via holes Via 1,Via 2 are disposed at an intersection of the interconnects M1,M2,M3 (that is, an intersection of grid lines GLx,Gly). The via holes Via 1,Via 2 are also called “through-holes” and they are hole patterns for electrically connecting the interconnects of different interconnect layers. The via hole Via 1 is a hole pattern for connecting the interconnects M1 and M2, while the via hole Via 2 is a hole pattern for connecting the interconnects M2 and M3. FIG. 8 is a view illustrating a group of primitive cells while overlapping them with grid lines GLx,GLy showing an interconnect channel. The contact holes CNT are disposed at intersections, among the intersections with grid lines GLx,GLy, which can be connected with the primitive cell 2.

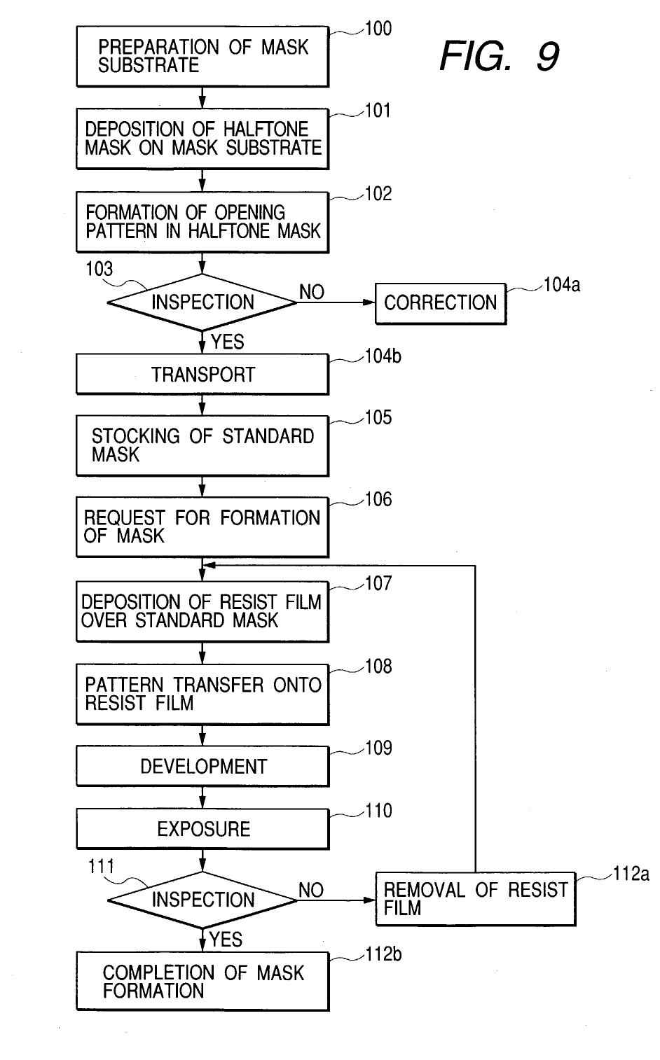

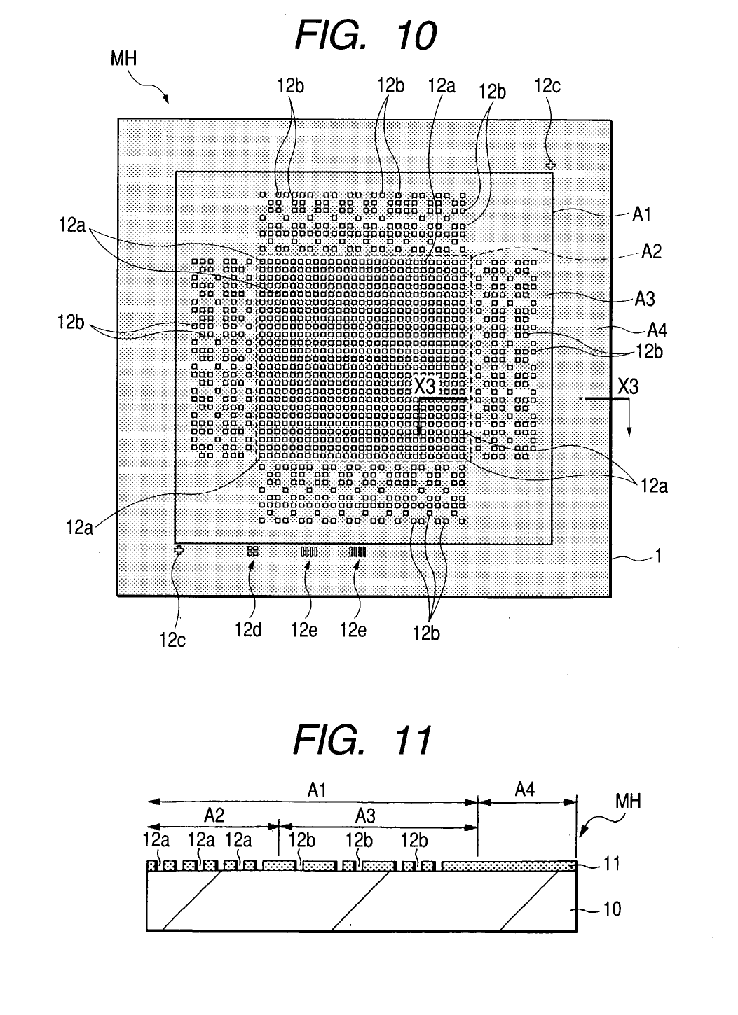

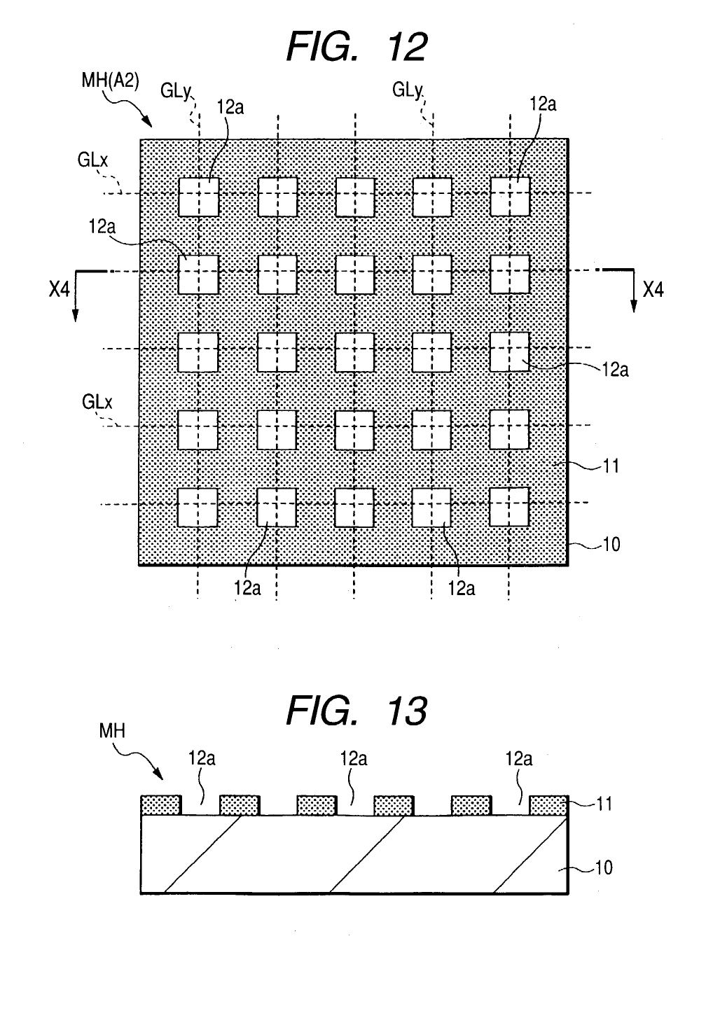

In the next place, with reference to FIGS. 10 to 34, a mask fabrication process of the present Embodiment 1 used upon fabrication step (exposure step) of a gate array will be described in accordance with the mask fabrication chart of FIG. 9 First, a making step of a standard mask (Steps 100 to 105 in FIG. 9) will be described. FIG. 10 is an overall plan view of a standard mask (first mask) MH during the mask fabrication step of Embodiment 1, FIG. 11 is a cross-sectional view taken along a line X3-X3 of FIG. 10, FIG. 12 is an enlarged fragmentary plan view of a region for transferring the internal circuit region of the standard mask MH of FIG. 10, and FIG. 13 is a cross-sectional view taken along a line X4-X4 of FIG. 12.

In this Embodiment 1, a mask to be used for transferring the contact hole CNT to a wafer is described as one example. First, a mask substrate 10 which is flat and has a square plane is prepared (Step 100 of FIG. 9). The mask substrate 10 is made of a synthetic quartz glass plate which is transparent to an exposure light and it has a first main surface and a second main surface on the reverse side (back side) thereof. Then, over the first main surface of the mask substrate 10, for example, a halftone film 11 is deposited (Step 101 of FIG. 9). The halftone film 11 is also called a translucent film or a semi-light shielding film and has a function of reducing the transmittance of an exposure light to 1% or greater but less than 40%. It has also a function of reversing the phase of a light transmitted through the halftone film 11 by 180° from the phase of a light transmitting through a light transmission region free of the halftone film 11. In this Embodiment 1, molybdenum silicide (MoSi) having a transmittance of an exposure light (for example, KrF) of about 1 to 6% and have a thickness of about 50 to 100 nm is deposited as the halftone film 11 by sputtering. The material of the halftone film 11 is not limited to it but various materials are usable. For example, chromium oxynitride (CrON) or chromium (Cr) can be employed. In this case, the thickness of the film is adjusted so as to reduce the transmittance of an exposure light to the above-described value. Then, an electron beam sensitive resist film is deposited over the halftone film 11 by the coating method. After writing opening patterns on the resist film, development and the like are conducted to form an electron beam sensitive resist pattern. With the electron beam sensitive resist pattern as an etching mask, the halftone film 11 exposed therefrom is etched to form opening patterns 12a to 12c. The electron beam sensitive resist pattern is then removed, whereby a standard mask MH is manufactured (Step 102 of FIG. 9). The standard mask MH is then inspected for the existence of opaque defect or clear defect and quality of the phase difference of a transmitted light (Step 103 of FIG. 9). If correctable defects are found as a result of the inspection, they are corrected (Step 104a of FIG. 9) and the corrected mask is inspected again. The standard mask MH which has passed the inspection is transported and then stocked (Steps 104b,105).

The standard mask MH thus made is a mask commonly used for the formation of hole patterns of various products. Its principal constitution is a halftone phase shift mask. The standard mask MH has, on the first main surface thereof, four regions, A1,A2,A3,A4. The region A1 of a square shape encompassed by the outermost peripheral closing line shows a transfer region of the patterns of the above-described chip 1C. The region (first region) A2 of a square shape at the center in the region A1 is a transfer region of hole patterns of the above-described internal circuit region CA. In this region A2, a plurality of opening patterns 12a having a square plane are closely and regularly arranged in rows. These opening patterns 12a are patterns for transferring the contact holes CNT in the internal circuit region CA. In this embodiment 1, the opening patterns 12a are disposed at the positions corresponding to all the intersections of grid lines GLx,GLx of the plurality of interconnect channels. On the first main surface of the standard mask MH, opening patterns 12a are also formed at positions corresponding to intersections of the grid lines GLx,Gly at which no contact holes CNT are disposed. By disposing the opening patterns 12a at all the intersections of the grid lines GLx,GLy, continuity of the arrangement of the opening patterns 12a can be maintained and without high accuracy in in-plane evenness accuracy or density correction accuracy, accuracy in the shape or size necessary for minute opening patterns 12a can be improved. In addition, by forming the opening patterns 12a at all the intersections of the grid lines GLx,GLy, formation of them at wrong positions can be avoided and the yield of the standard mask MH can be improved. It is not always necessary to dispose opening patterns 12a at positions corresponding to the intersections of grid lines GLx,GLy which exist in the above-described isolation region.

The frame-like region (second region) A3 which lies in the region A1 but at the periphery of the region A2 is a transfer region of the hole patterns of the above-described peripheral circuit region I/O. In this region A3, a plurality of opening patterns 12b having a square plane are regularly disposed. These opening patterns 12b are each a pattern of transferring the contact hole CNT within the peripheral circuit region I/O. The opening patterns 12b are also disposed at positions corresponding to the intersections of the grid lines GLx,GLy of the plurality of interconnect channels, but they are disposed at not all the intersections but only the positions necessary for the formation of a peripheral circuit.

The region (third region) A4 at the periphery of the region A1 is a peripheral region of the standard mask HM itself corresponding to the periphery of the chip IC. In this region A4, no patterns for transferring integrated circuit patterns are formed, but opening patterns 12c to 12e serving as mark patterns are formed. The opening patterns 12c disposed in the vicinities of the corners of the region A1 opposite to each other are patterns for transferring, onto the wafer, mark patterns used for positional alignment of the mask and wafer. The opening patterns 12d,12e are patterns for transferring, onto the wafer, mark patterns for another positional alignment, measurement or identification. It is also effective to form, in the halftone film 11 of the standard mask MH, an opening pattern serving as a positional alignment mark of the standard mask MH and an electron beam lithography system used upon formation of a pattern of the below-described resist film capable of blocking an exposure light.

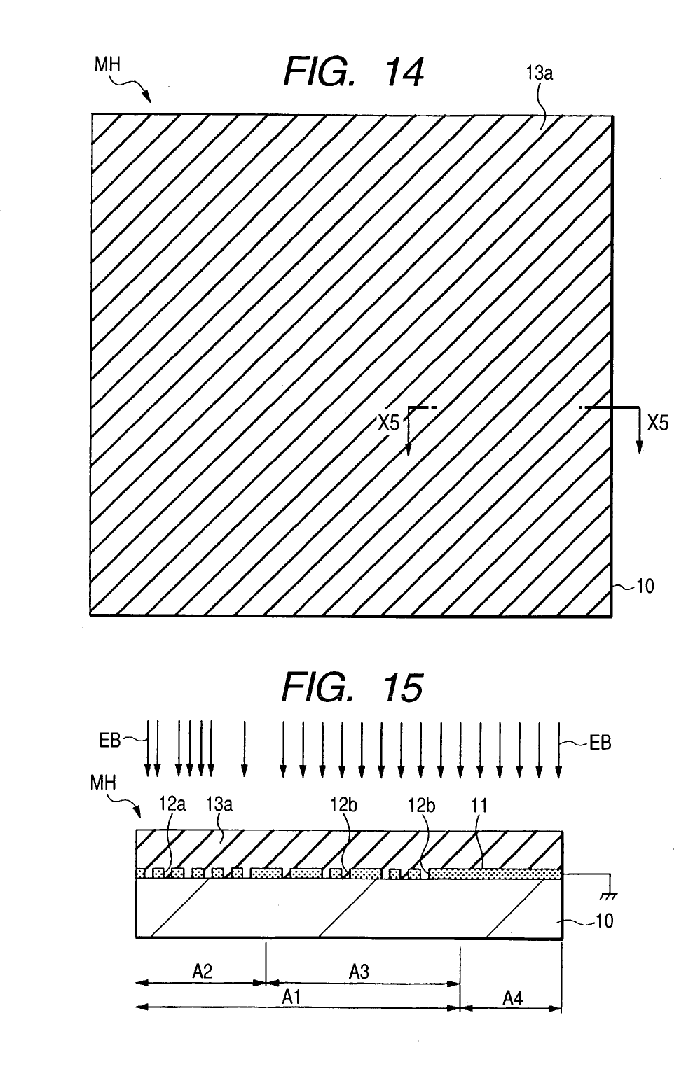

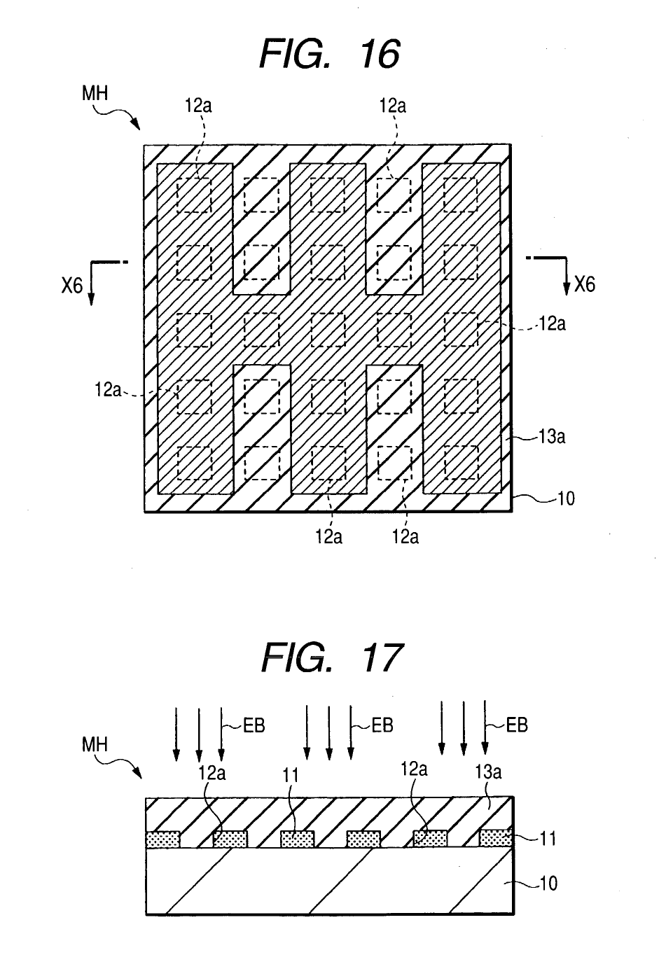

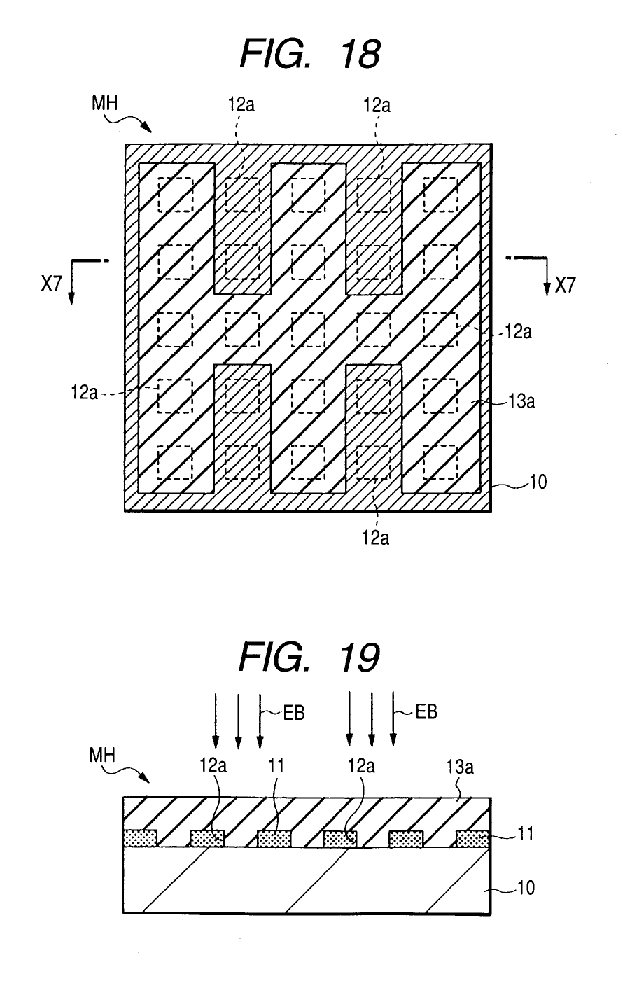

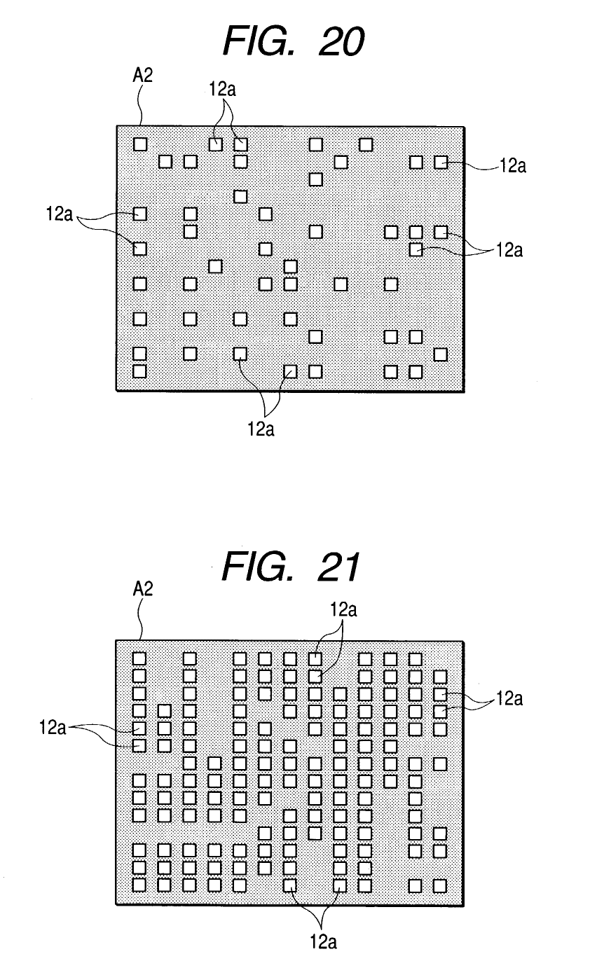

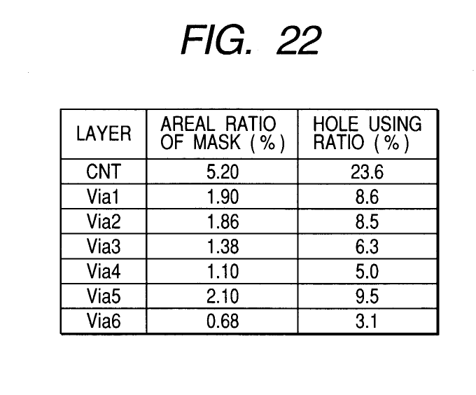

Steps (Steps 106 to 108 of FIG. 9) from receipt of an order for the mask fabrication until transfer of patterns to a resist film capable of blocking an exposure light will next be described. FIG. 14 is an overall plan view of the standard mask MH during the manufacturing step of the mask following the step of FIG. 10, FIG. 15 is a cross-sectional view taken along a line X5-X5 of FIG. 14, FIG. 16 is an enlarged fragmentary plan view of a region for transferring the internal circuit region of the standard mask MH of FIG. 14, FIG. 17 is a cross-sectional view taken along a line X6-X6 of FIG. 16, FIG. 18 is a modification example of FIG. 17, FIG. 19 is a cross-sectional view taken along a line X7-X7 of FIG. 18, FIGS. 20 and 21 are each an explanatory view of one example of the disposal of opening patterns 12a necessary in the region A2, and FIG. 22 is an explanatory view of one example of a hole using ratio of a standard product.

First, an electron beam sensitive resist film 13a is deposited over the first main surface of the standard mask MH by the coating method. This electron beam sensitive resist film 13a is capable of blocking an exposure light when the wafer is subjected to an exposure treatment. Its thickness is, for example, about 500 to 600 nm (Step 107 of FIG. 9). Illustrated in FIGS. 15 to 17 is the standard mask coated with the positive electron beam sensitive resist film 13a, while illustrated in FIGS. 18 and 19 is the standard mask coated with the negative electron beam sensitive resist film 13a. Then, desired patterns are written on the electron beam sensitive resist film 13a by exposing the desired positions of the electron beam sensitive resist film 13a to electron beam EB (Step 108 of FIG. 9). Upon this lithography, only the necessary opening patterns 12a are exposed in the region A2 and unnecessary opening patterns 12a are covered with the electron beam sensitive resist film 13a. In short, necessary opening patterns 12a are selected. In the regions A3 and A4, electron beam sensitive resist film 13a does not remain in the end, because the arrangement of the opening patterns 12b required in the region A3 for transferring the hole patterns of a peripheral circuit are conventionally determined and there is almost no necessity to select opening patterns by using a resist film. If the electron beam sensitive resist film 13a remains in the region A4, a part of which is brought into contact with a mask support of an exposure system or mask inspection apparatus or a pellicle, it is causative of generation of foreign matters or pellicle peeling. Patterns formed by the above-described lithography are much larger than the opening patterns 12a so it is needless to become nervous about microfabrication or the like.

In FIGS. 16 and 18, a region exposed to electron beam EB is hatched with thin lines. In FIGS. 16 and 18, patterns equal in shape are left in the electron beam sensitive resist film 13a. In FIGS. 15 to 17, since the positive electron beam sensitive resist film 13a is used, a region written by electron beam EB is removed by development. In FIGS. 18 and 19, since the negative electron beam sensitive resist film 13a is used, a region written by an electron beam EB is left and a region not exposed to an electron beam EB is removed by development. In this Embodiment 1, the electron beam sensitive resist film 13a is left in neither the region A3 nor the region A4 in the end so that when the positive film is used, the whole electron beam sensitive resist film 13a in the regions A3 and A4 is exposed to electron beam EB, while when the negative film is used, neither the region A3 nor the region A4 is exposed to electron beam EB.

It is preferred to select the positive or negative film as the electron beam sensitive resist film 13a properly depending on the using ratio of the opening patterns 12a. FIGS. 20 and 21 each illustrates one example of the arrangement of opening patterns 12a necessary in the region A2. FIG. 20 illustrates the arrangement in which a ratio of the necessary opening patterns 12a is smaller than that of the arrangement illustrated in FIG. 21. In this case, use of the positive electron beam sensitive resist film 13a enables a decrease in the writing area, thereby improving a writing throughput. In the case of FIG. 21, on the other hand, a ratio of the necessary opening patterns 12a is relatively large so that use of the negative electron beam sensitive resist film 13a enables a decrease in the writing area, thereby improving a writing throughput. The using ratio of the opening patterns 12a (hole patterns) differs greatly, depending on product, using purpose or packaging ratio. In this Embodiment 1, the film type can be selected depending on the using ratio of the opening patterns 12a (hole patterns) so that it is possible to fabricate a mask in a short TAT irrespective of the using ratio. FIG. 22 illustrates a hole using ratio of hole patterns (contact holes CNT and via holes Via 1 to Via 6) of a semiconductor integrated circuit device having a CMIS circuit of 0.14 μm. The hole using ratio is a ratio of hole patterns required for the formation of a target product relative to hole patterns disposed at all the intersections of the interconnect channel within the region A2 of the standard mask MH. This ratio is calculated, while setting a ratio of the pitch between two adjacent hole patterns and the diameter of the hole pattern at 2:1. The hole using ratio of this standard product is about ¼ of the whole chip so that it is advantageous to use the positive electron beam sensitive resist film 13a for the mask fabrication.

In the electron beam lithography in the step 108, a part of the halftone film 11 (a part of the outermost periphery of the standard mask MH) is electrically connected to a ground potential GND in advance. Since the halftone film 11 has conductivity and is formed without separation in the first main surface of the mask substrate 10, this electric connection makes it possible to release, to the ground potential GND, charges generated by exposure to an electron beam and therefore, to suppress or prevent accumulation of charges. It is therefore possible to reduce or prevent generation of failures including misalignment due to charge up. Although the conventional vector scanning system with a variable-rectangular-shape electron beam is employed for electron beam lithography, not only it but also various methods are usable. For example, a raster scanning or vector scanning system with a circular beam may be adopted as in the conventional electron beam lithography. Alternatively, a regional full plate exposure system (cell projection system) may be employed. Described specifically, a shaping aperture of an electron beam lithography system is formed, in advance, to have a pattern which is to be written (a relatively large pattern embracing a plurality of opening patterns 12a or opening patterns 12b) and predetermined regions on the standard mask MH may be simultaneously exposed to an electron beam by using the pattern. This enables an improvement in the writing throughput. Alternatively, the regions A3,A4 may be exposed in the following manner when the positive resist film is used. First, the regions A3,A4 are simultaneously exposed to an ultraviolet light by using a mask capable of shielding the region A2 from the light. Then, the desired positions in the region A2 of the resist film are exposed to electron beam EB by the above-described electron beam lithography system to transfer the desired patterns. The regions A3,A4 which are large in area can be exposed to a light simultaneously, whereby the throughput can be improved. When the positive electron beam sensitive resist film 13a is applied, it may be partially applied to the region A2 of the standard mask MH by using the scan coating method. The scan coating method is a method for selectively applying the electron beam sensitive resist film 13a to the target by injecting it from a resist coating nozzle only to a region which needs coating of the electron beam sensitive resist film 13a, while scanning the resist coating nozzle relative to a surface to be coated with the resist. This method is also usable for the application of the negative electron beam sensitive resist film 13a.

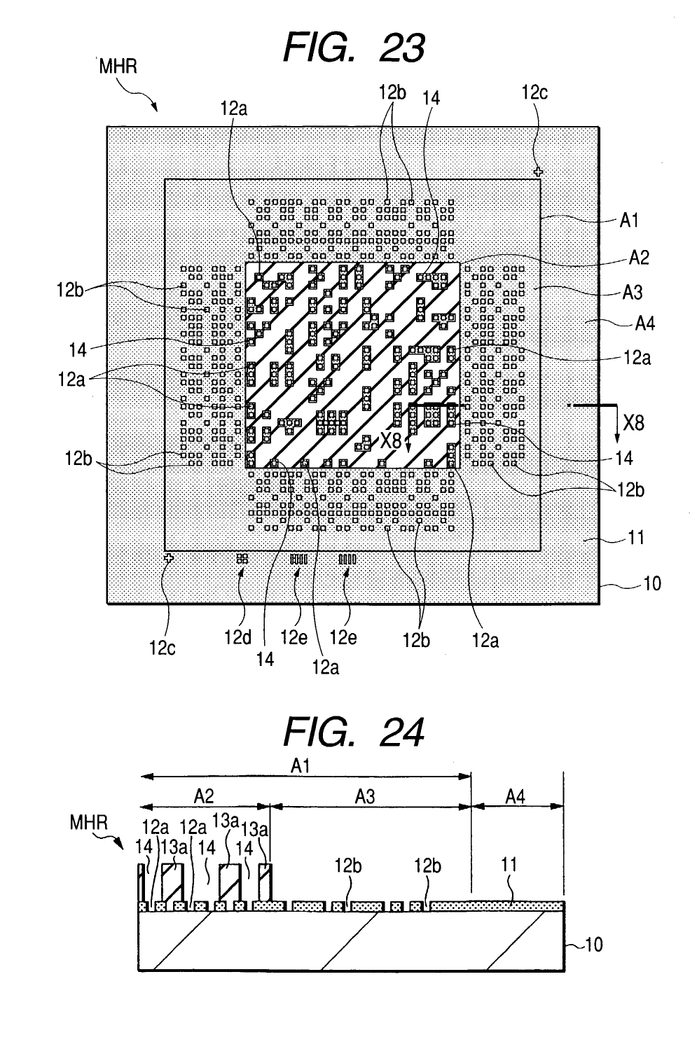

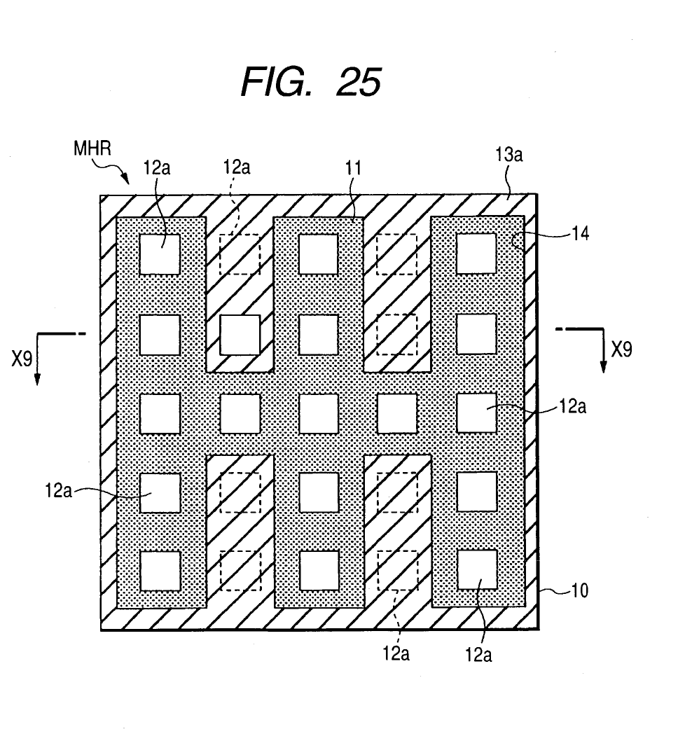

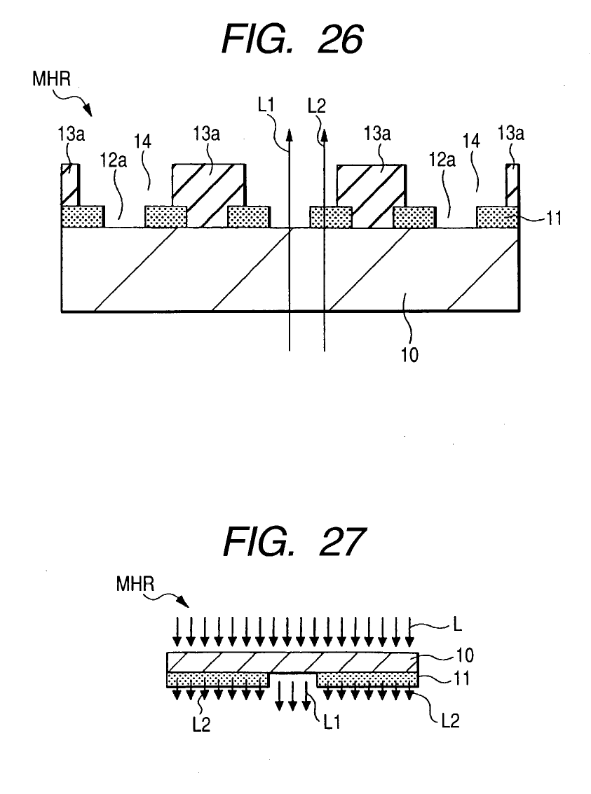

In the next place, steps from development to completion of the mask (Steps 109 to 112b of FIG. 9) will be described. FIG. 23 is an overall plan view illustrating one example of the mask MHR (second mask) of FIG. 23 which has been completed; FIG. 24 is a cross-sectional view taken along a line X8-X8 of FIG. 23; FIG. 25 is an enlarged fragmentary plan view of the region A2 of FIG. 23; FIG. 26 is a cross-sectional view taken along a line X9-X9 of FIG. 25; FIGS. 27 to 29 are each an explanatory view of phase adjusting effect of exposure light; and FIG. 30 is an explanatory view of the arrangement of a resist pattern capable of blocking an exposure light.

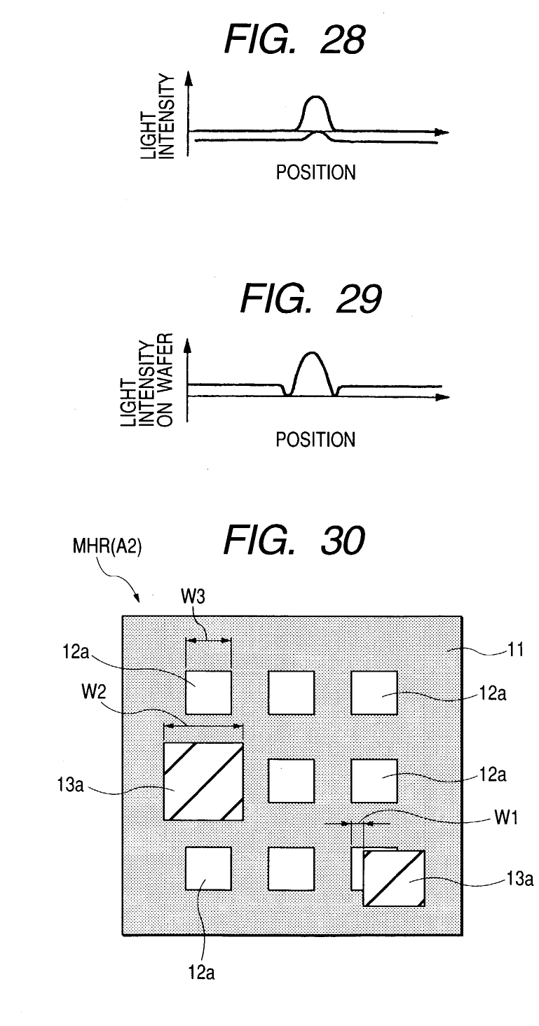

The mask MHR is formed by developing the standard mask subjected to electron beam lithography, thereby forming a pattern made of the electron beam sensitive resist film 13a (Step 109 of FIG. 9). The mask MHR of this Embodiment 1 is a resist mask formed of a halftone type phase shift mask as a principal component (component common to a plurality of products). In the region A2 of the mask MHR, a portion having an unnecessary opening pattern 12a is shielded from a light by laying thereover the pattern of the electron beam sensitive resist film 13a. From a portion of the region A2 in which a necessary opening pattern 12a is disposed, on the other hand, the electron beam sensitive resist film 13a has been removed and an opening pattern 14 is formed. From this opening pattern 14, the whole portion of the necessary opening patterns 12 and a portion of the halftone film 11 at the periphery thereof are exposed. By such a structure, an opening pattern 12a necessary for the target gate array is selected. From the opening pattern 14, one or a plurality of the opening patterns 12a may be exposed. From the opening pattern 14, the halftone film 11 around the opening pattern 12a is also exposed. As illustrated in FIGS. 25 to 28, this makes it possible to reverse, relative to an exposure light L1 transmitting through the opening pattern 12a upon exposure treatment of the wafer, the phase of an exposure light L2 transmitting through the halftone film 11 existing around the opening pattern 12a by 180°. FIG. 27 schematically illustrates a fragmentary cross-sectional view which schematically illustrates the mask MHR upon exposure treatment of the wafer. The exposure light L is irradiated from the second main surface of the mask MHR. There appears a 180° phase difference between the exposure light L1 transmitting through the opening pattern 12a of the mask MHR and the exposure light L2 transmitting through the halftone film in the vicinity of the opening pattern 12a. FIG. 28 illustrates distribution of an exposure light intensity just after the light has transmitted the mask MHR of FIG. 27, while FIG. 29 illustrates the distribution of the exposure light intensity on the wafer. Inversion of the phase between the exposure lights L1 and L2 as described above makes it possible to improve the contrast of the light intensity in the vicinity of the edge of a hole pattern to be transferred to the photoresist film on the wafer, thereby improving resolution and depth of focus of the hole pattern.

As illustrated in FIG. 30, it is only necessary that the electron beam sensitive resist film 13a covers about 50% of the area of the opening pattern 12a, because if about 50% is covered, the pattern is not transferred onto the wafer. Accordingly, high accuracy is not required for the alignment of the opening pattern 12a with the pattern of the electron beam sensitive resist film 13a (that is, alignment accuracy upon electron beam lithography). The width W1 is a shift amount generated upon alignment of the opening pattern 12a with the pattern of the electron beam sensitive resist film 13a. The width W2 of one side of the pattern of the electron beam sensitive resist film 13a is required only to be greater than the width W3 of one side of the opening pattern 12a and the pattern of the electron beam sensitive resist film 13a is not required to have high size accuracy (that is, size accuracy upon electron beam lithography). In the regions A3,A4 of the mask MHR, on the other hand, the electron beam sensitive resist film 13a is eliminated and all the opening patterns 12b, all the opening patterns 12c to 12e for marking and the halftone film 11 are exposed. A description of a resist mask can be found, for example, in Japanese Patent Laid-Open No. Hei 11(1999)-185221 (filed on Jun. 30, 1999), Japanese Patent Application No. 2000-246466 (filed on Aug. 15, 2000), Japanese Patent Application No. 2000-246506 (filed on Aug. 15, 2000), Japanese Patent Application No. 2000-308320 (Oct. 6, 2000), Japanese Patent Application No. 2000-316965 (filed on Oct. 17, 2000), Japanese Patent Application No. 2000-328159 (filed on Oct. 27, 2000), Japanese Patent Application No. 2000-206728 (filed on Jul. 7, 2000) and Japanese Patent Application No. 2000-206729 (filed on Jul. 7, 2000).

The photoresist film on a dummy wafer is then subjected to the conventional reduction projection exposure treatment using the mask MHR thus formed, whereby desired contact hole patterns are transferred onto the wafer and a photoresist pattern having, opened therein, contact hole patterns is formed through development (Step 110 of FIG. 9). The quality of the mask MHR is checked by inspecting the photoresist pattern of the dummy wafer (Step 111 of FIG. 9). Of course, the mask itself may be inspected. Since the opening pattern 14 is larger than the opening pattern 12a, the inspection at this time can be carried out in a relatively easy manner. When the mask does not pass the inspection, the pattern of the electron beam sensitive resist film 13a on the mask MHR is ashed and the resulting mask is returned to the step 107. It is impossible to reform the mask if it is a conventional halftone phase shift mask, because reforming deteriorates the quality of the mask substrate 10. If some defects which cannot be corrected exist in the halftone phase shift mask, a new mask substrate 10 is prepared and steps must be started again from the deposition of a halftone film. The conventional halftone phase shift mask, therefore, is accompanied with such drawbacks that it takes time to make it and moreover, the mask substrate 10 once used must be discarded and cannot be recycled, which leads to a rise in the cost of the mask. In the mask MHR of this Embodiment, on the other hand, the electron beam sensitive resist film 13a can be removed easily by a development solution, which makes it possible to reform the mask MHR easily, in a short time without causing a damage to the standard mask MH. In addition, the standard mask MH can be used again, which can eliminate the waste of a material, thereby lowering the fabrication cost of the mask MHR (Step 112a of FIG. 9). When the mask passes through the inspection step 111, it means the completion of the mask MHR (Step 112b of FIG. 9).

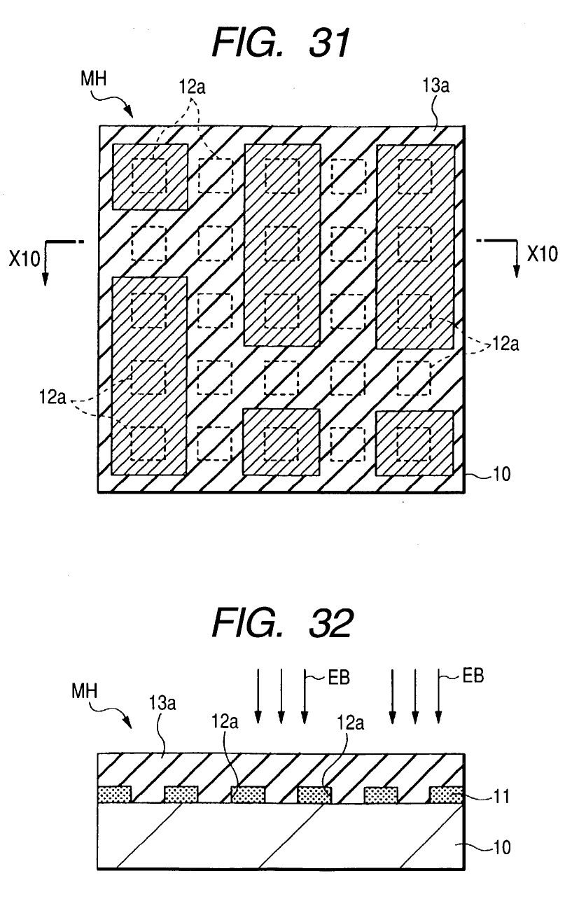

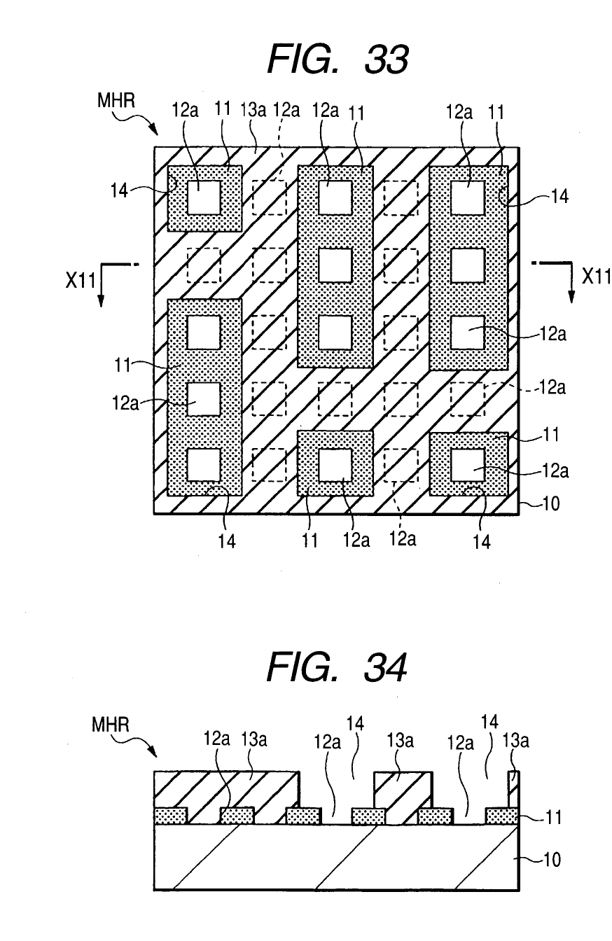

In the next place, one example of a response to a change in the logic will be described with reference to FIG. 9 and FIGS. 31 to 34. FIG. 31 is a plan view of the region A2 of the mask MH, upon pattern transferring step 108 of FIG. 9, at the same position as illustrated in FIG. 16; FIG. 32 is a cross-sectional view taken along a line X10-X10 of FIG. 31; FIG. 33 is a plain view of the region A2 of the mask MHR after the development step 109 of FIG. 9 at the same position as illustrated in FIG. 25; and FIG. 34 is a cross-sectional view taken along a line XII-XII of FIG. 33. In ASIC (Application Specific IC) such as gate array, the logic is sometimes changed. In such a case, the mask fabrication is started from the step 107 of FIG. 9 in this Embodiment 1. Described specifically, after application of a positive electron beam sensitive resist film 13a to the first main surface of the standard mask MH as described above, the electron beam sensitive resist film 13a is subjected to lithography using an electron beam EB in the above-described manner as illustrated in FIGS. 31 and 32, based on pattern data corresponding to a new logic (Steps 107,108 of FIG. 9). Here, a region subjected to electron beam lithography is different from that of FIG. 16. After development, exposure and inspection steps (Steps 109 to 111 of FIG. 9), the fabrication of a mask MHR as illustrated in FIGS. 33 and 34 is completed. The opening patterns 14 are formed to be different from those of FIG. 25. In such a manner, it is possible to respond to a change in the logic.

The fabrication method of the mask MHR according to this Embodiment 1 (steps starting from receipt of an order for the fabrication of a mask until completion of the mask) brings about the below-described advantages over a conventional halftone phase shift mask.

From the viewpoint of pattern transfer by electron beam lithography, the conventional halftone phase shift mask having no light shielding body requires high accuracy in in-plane evenness, density correction and size accuracy, cannot be written easily and tends to be low in a writing yield. In this Embodiment 1, on the other hand, no high accuracy is required for writing in the electron beam lithography step (step 108 for transferring patterns to a resist film) as described above so that lithography can be performed at ease and in an improved yield. From the viewpoints of processing accuracy and quality, foreign matters tend to adhere to the conventional halftone phase shift mask because it must pass through many steps such as lithography, etching and washing, which deteriorates the accuracy upon completion. In this Embodiment 1, on the other hand, since processing, washing and dry etching steps can be eliminated, an amount of foreign matters can be reduced and therefore, accuracy can be improved, whereby the reliability and yield of the mask MHR can be improved. From the viewpoint of TAT of mask fabrication, the conventional halftone phase shift mask requires a complex fabrication process and in addition, needs a step of inspecting the transmittance or phase difference of the halftone film 11 which step takes much time and a transporting step after mask fabrication, leading to a delay in the delivery time of the mask. This problem will worsen with the miniaturization tendency of patterns to be transferred to a wafer. In this Embodiment 1, on the other hand, the mask MHR is fabricated with the standard mask, which has passed the above-described inspection and been stocked, as a starting material so that various steps such as a step of inspecting the transmittance or phase difference and a transporting step can be eliminated. In addition, the mask inspection can be carried out in a relatively easy manner, which leads to shortening of the delivery time of the mask MHR and, in turn, the delivery time of the gate array. From the viewpoint of the mask cost, the conventional halftone phase shift mask needs, as well as a complex fabrication process, a sophisticated inspection step which requires high accuracy and a transporting step after mask fabrication so that the cost of the mask inevitably becomes high. In this Embodiment 1, on the other hand, various steps such as a complex fabrication process, sophisticated inspection step and transporting step as described above are not necessary so that the cost of the mask MHR can be reduced drastically. Moreover, it is possible to stably mass produce the standard mask and to promote a further reduction in the fabrication cost because the density of opening patterns is not different among products. From the viewpoint of a change in logic, advantages as described below are available. There is an increasing demand for shortening the delivery time of ASIC such as gate array, because with heightening of the function of ASIC such as a gate array, the step number or term necessary for development of such a product increases, but obsolescence of the product is rapid and its lifetime is short. In the case of ASIC, products designed in accordance with the requested specifications of a user are manufactured in the amount requested by the user, so the production amount is usually smaller than that of memory products in spite of an increase in the varieties of the products. In most cases, a cost down by volume efficiency cannot be expected. It is therefore an important theme in the mask fabrication how to avoid waste and suppress the cost. In the case of the conventional halftone phase shift mask, it takes a tremendous time and cost for completing it, because upon a change in logic, it is necessary to prepare a new mask substrate, deposit a halftone film thereover, make opening patterns in the halftone film by etching and carry out sophisticated and time-consuming inspection such as inspection of transmittance or phase difference of the halftone film 11. In this Embodiment 1, on the other hand, the mask MHR is manufactured using the standard mask as a starting material so that it is possible to respond to a change in the logic easily in a short time while maintaining high quality of the mask. This makes it possible to actualize shortening of the delivery time of a gate array and cost reduction. From the overall viewpoint, the number of steps tends to increase in the case of the conventional halftone phase shift mask owing to the formation of minute opening patterns and halftone specification. In this Embodiment 1, on the other hand, the number of steps can be reduced drastically because necessary opening patterns 12a are selected only by forming a resist film pattern.

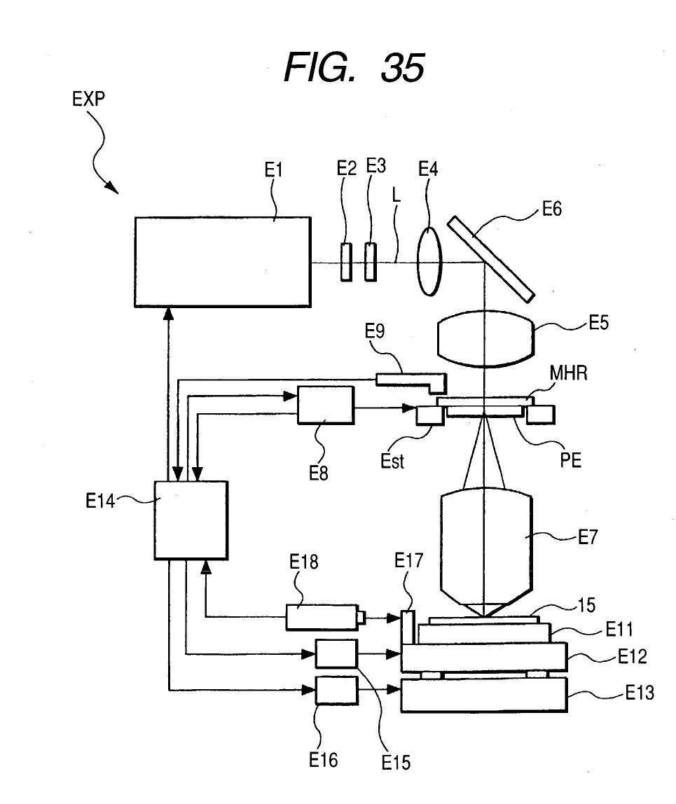

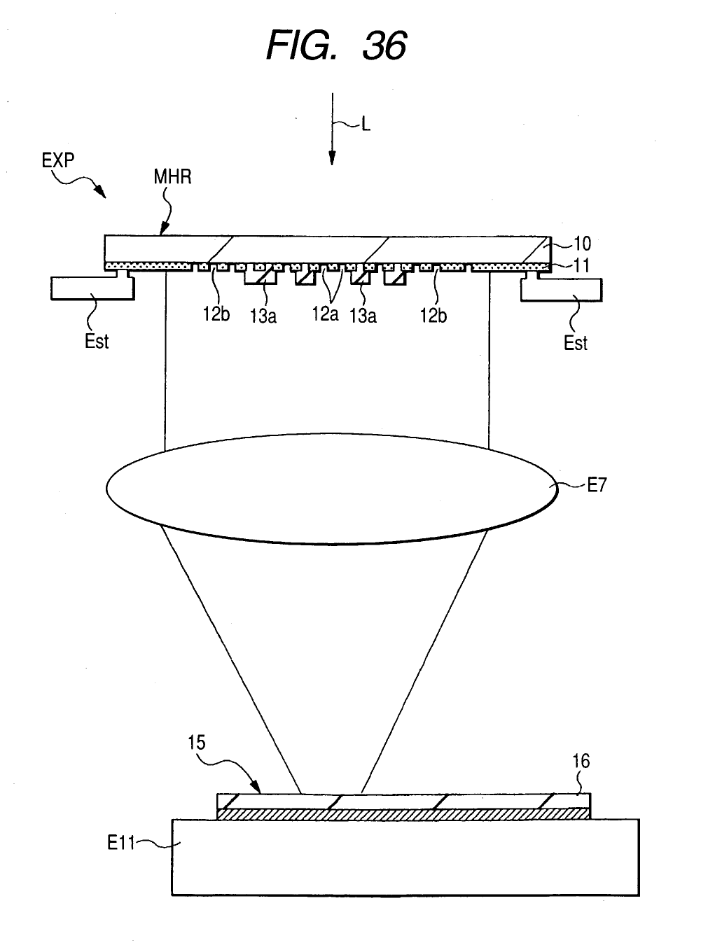

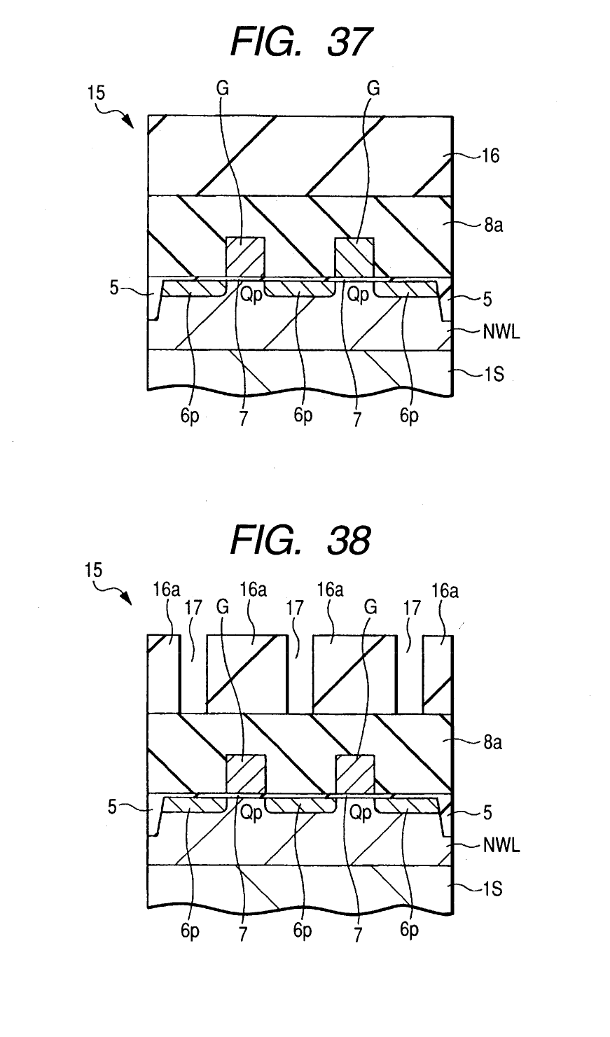

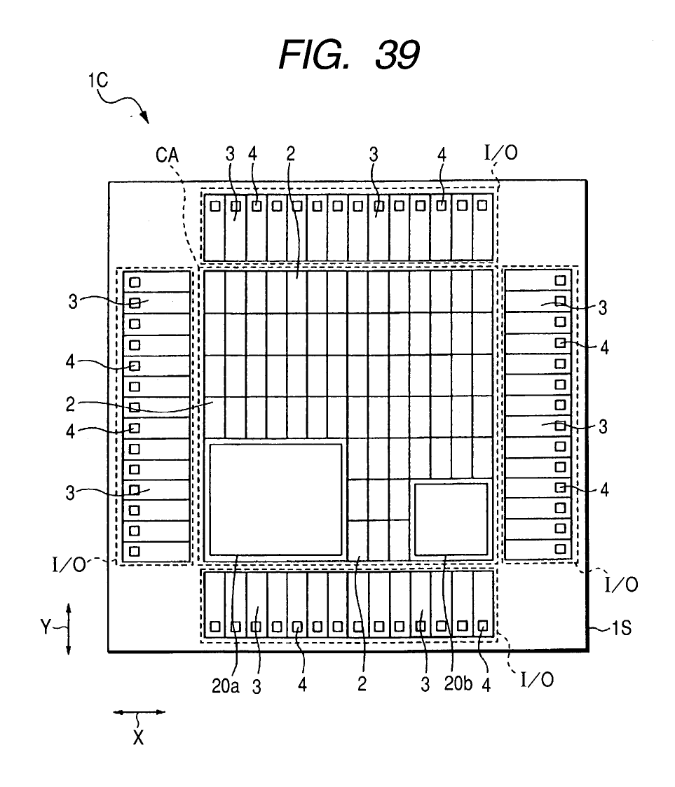

One example of transfer of hole patterns onto a wafer by the exposure method using the above-described mask MHT will next be described with reference to FIGS. 35 to 38. FIG. 35 is an explanatory view of one example of an exposure system; FIG. 36 is an explanatory view of exposure treatment; FIG. 37 is an enlarge fragmentary cross-sectional view of the wafer 15 upon treatment of FIG. 36; and FIG. 37 is a fragmentary cross-sectional view of the wafer 15 after development. In FIG. 35, only parts necessary for describing the function of the exposure system are illustrated. This equipment is similar to the conventional exposure system (scanner or stepper) in another common part.

An exposure system EXP is, for example, a scanning type reduction projection exposure system (scanner) having a reduction ratio of 4:1. Exposure conditions of this exposure system EXP are as follows. Described specifically, as an exposure light L, a KrF excimer laser light having an exposure wavelength of 248 nm is used. The numerical aperture NA of an optical lens is 0.65. The illumination has a circular shape and coherence (σ: sigma) is 0.7. As the mask, a conventional mask as well as a resist mask such as the above-described MHR is used. The exposure light L is not limited to the above-described one but various types such as g-line (wavelength: 436 nm), i-line (wavelength: 365 nm), ArF excimer laser light (wavelength; 193 nm), F₂ gas laser light (wavelength: 157 nm) and ultraviolet ray (wavelength: to 13 nm) are usable.

The exposure light L emitted from the exposure light source E1 illuminates the mask MHR (here, a reticle) via fly eye lens E2, aperture E3, condenser lenses E4,E5 and mirror E6. Of the optical conditions, the coherence was adjusted by changing the size of the opening portion of the aperture E3. On the mask MHR, the above-described pellicle is disposed in order to prevent pattern transfer failure due to adhesion of foreign matters. The mask patterns written on the mask MHR are projected, via a projection lens E7, onto a wafer 15 which is a substrate to be treated. The mask MHR is mounted on a stage Est controlled by the mask position controlling means E8 and mirror E9 so that its center is precisely aligned with the optical axis of the projection lens E7. The mask MHR is placed on the stage Est with its first main surface in a face-to-face position with the main surface (device surface) of the wafer 15 and with its second main surface in a face-to-face position with the condenser lens E5. Accordingly, the exposure light L is irradiated from the second main surface side of the mask MHR, passes through the mask MHR and then irradiated to the projection lens E7 from the first main surface side of the mask MHR.

The wafer 15 is vacuum-adsorbed on a wafer stage E11 with its main surface being turned to the side of the projection lens E7. The wafer 15 is made of a thin plate having a substantially circular plane and it has the above-described element formation substrate 1S as a principal component. Over the main surface of the wafer, a photoresist film 16 which is sensitive to the exposure light L is applied as shown in FIGS. 36 and 37. The wafer stage E11 is placed on a Z stage E12 which is movable in an optical axis direction of the projection lens 7, that is, in a vertical direction to the substrate placed plane of the sample stage E11 (in a Z direction), and is further placed on an XY stage E13 which is movable in a direction parallel to the substrate placed plane of the sample stage E11. The Z stage E12 and the XY stage E13 are respectively driven by driving means E15 and E16 in accordance with control commands given by a main control system E14, whereby they can be moved to desired exposure positions. The exposure position is precisely monitored by a laser precision distance meter E18 as the position of a mirror E17 fixed to the Z stage E13. The surface position of the wafer 15 is measured by a focus position detecting means that a conventional exposure system has. Driving the Z stage E12 in accordance with the measurement results can make the main surface of the wafer 15 coincide with an image forming surface of the projection lens E7.

The mask MHR and wafer 15 are driven in sync in accordance with a reduction ratio and the mask patterns are transferred in a reduction form onto the wafer 15 while the exposure region scans over the mask MHR. The driving of the surface position of the wafer 15 is also dynamically controlled relative to the scanning of the wafer 14 by the above-described means. In the case where a circuit pattern on the mask MHR is overlaid on another circuit pattern formed on the wafer 15 and then is exposed, positions of the mark pattern formed on the wafer 15 are detected by using an alignment optical system, and the wafer 15 is positioned in accordance with the detected results and is overlaid and transferred. The main control system E14 is electrically connected to a network apparatus and can remote-monitor the state of the exposure system EXP. In the above description, a scanning type reduction projection exposure system (scanner) was used as an exposure system, but not only it but also a reduction projection exposure system (stepper) capable of transferring a circuit pattern on a mask to a desired position of a wafer by “step and repeat” of the wafer to the projected image of the circuit pattern on the mask.

After exposure treatment using such an exposure system EXP, the wafer 15 is developed, whereby resist pattern 16a made of a photoresist film 16 is formed over the main surface (insulating film 8a) of the wafer 15. From the resist pattern 16a, a contact hole formation region is exposed and another portion is covered with it. The opening pattern 17 formed in the contact hole formation region is a minute hole pattern having a substantially circular plane and from the bottom of the pattern, the upper surface of the insulating film 8a is exposed. After this step, with the resist pattern 16a as an etching mask, the insulating film 8a exposed therefrom is etched to form contact holes CNT as illustrated in FIGS. 4 and 5. In such a manner, fine contact holes CNT can be formed in the wafer 15 with a high size accuracy.

(Embodiment 2)

A semiconductor integrated circuit device according to Embodiment 2 is a cell based integrated circuit device such as embedded array (ECA: Embedded Cell Array). FIG. 39 is an overall plan view illustrating one example of a chip 1C constituting the semiconductor integrated circuit device of this Embodiment 2. The chip 1C of this Embodiment 2 has, in the internal circuit region CA thereof, macrocell parts (second logic circuit regions) 20a,20b. In these macrocell parts 20a,20b, special circuits as described above such as RAM, ROM or PLL (Phase-locked Loop) circuit are formed. This device is similar to that of Embodiment 1 except for the above-described constitution.

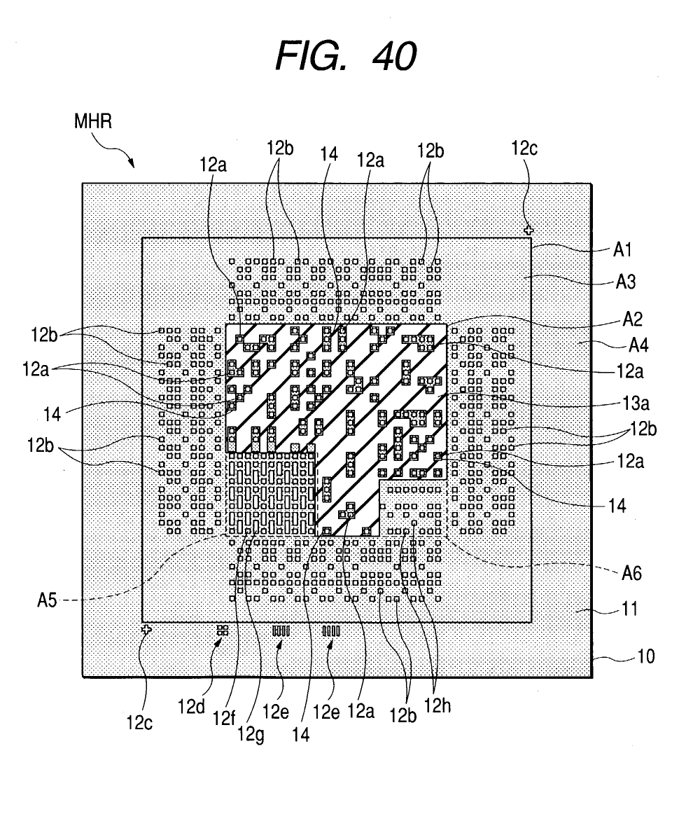

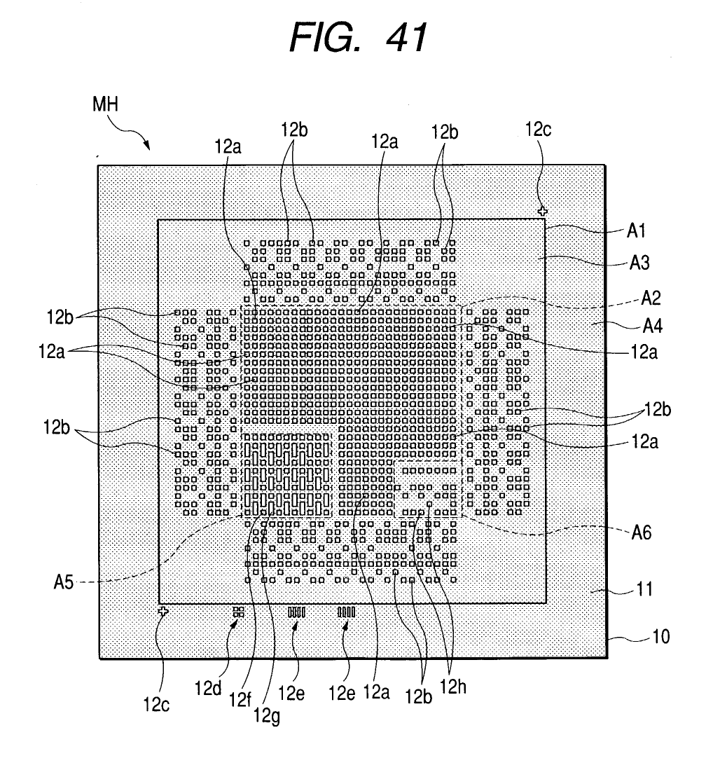

FIG. 40 is an overall plan view illustrating one example of a mask HMR to be used upon transfer of a hole pattern of the chip iC of FIG. 39 to a wafer; and FIG. 41 is an overall plan view illustrating one example of a standard mask MH of the mask MHR of FIG. 40. Regions (fourth regions) A5,A6 of the mask MHR are pattern transfer regions of the contact hole of the macrocell parts 20a,20b of FIG. 39, respectively. In the region A5, a plurality of opening patterns 12f,12g different in area which are for transfer of the contact holes of the macro cell 20a are formed, while in the region A6, a plurality of opening patterns 12h same in area which are for transfer of the contact holes of the macro cell 20b are formed. These regions A5,A6 are not covered with the electron beam sensitive resist film 13a but are exposed. In the regions A5,A6, disposed are only the opening patterns 12f,12g,12h for transferring the contact holes necessary for the formation of the circuit of the macrocell parts 20a,20b. The regions A5,A6 have a similar constitution to the region A3 for the transfer of a peripheral circuit region I/O, because components of the macrocell portions 20a,20b such as semiconductor regions (active region L) for source and drain and contact holes are almost fixed and do not require a change. Described specifically, design data of the macro cell parts 20a,20b include data on the optimum arrangement or size of the semiconductor regions (active regions L) for source and drain and contact holes. This arrangement or size has already been confirmed to enable stable operation. It is therefore advantageous, in order to obtain macrocell parts 20a,20b having stable operation, not to change the arrangement or size of each component such as semiconductor regions (active region L) for source and drain and contact holes. In such a cell based integrated circuit device, a change in the arrangement of via holes for electrically connecting macrocells or macro cell and another logic circuit is more frequently made than a change in the arrangement of the contact holes in the macrocell so that it is preferred to adopt the constitution as described above in Embodiment 1 for the mask to be used upon formation of the via holes. The mask in this Embodiment 2 is similar to the mask MHR of Embodiment 1 except for the above-described constitution. Described specifically, in a region A2 which undergoes a change in logic, opening patterns 12a are disposed at all the intersections of the grid lines of the interconnect channel and opening patterns 12a necessary for the circuit formation among these patterns and the halftone film 11 at the periphery thereof are exposed from the pattern of the electron beam sensitive resist film 13a as illustrated in FIG. 40.

According to this Embodiment 2, a semiconductor integrated circuit device having macrocell parts 20a,20b, which device is expected to exhibit stable operation and is highly reliable can be formed in a short term at a low cost.

(Embodiment 3)

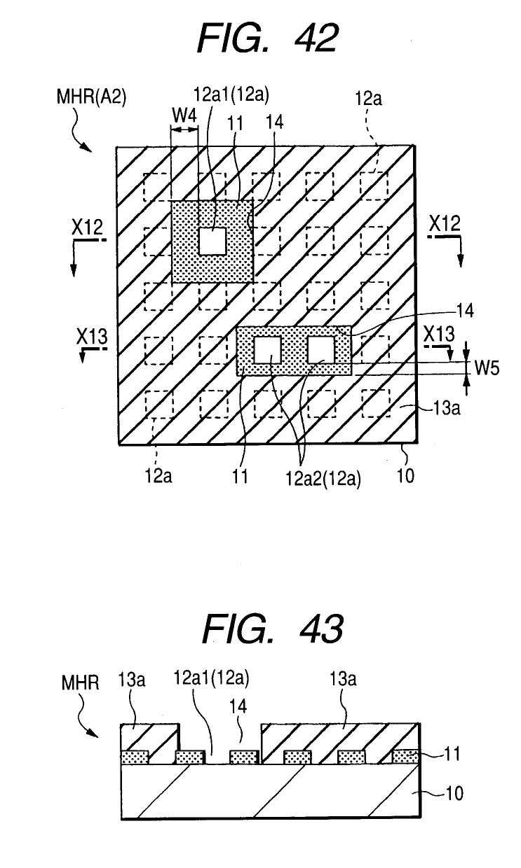

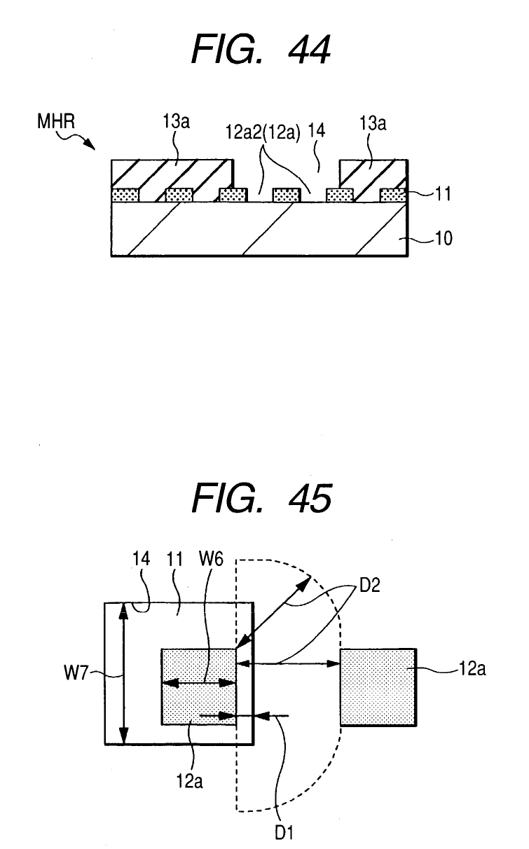

In this Embodiment 3, described is an application example of OPC (Optical Proximity Correction) to a mask having thereon a positive resist film. FIG. 42 is an enlarged fragmentary plain view of one example of OPC in the region A2 of the mask MHR; and FIGS. 43 and 44 are cross-sectional views taken along lines X12-X12 and X13-X13 of FIG. 42, respectively. An opening pattern 12a1 is a pattern for transferring a hole pattern isolated on a wafer, while an opening pattern 12a2 is a pattern for transferring a plurality of hole patterns existing in proximity one another on a wafer. In this Embodiment 3, by changing the size of the opening pattern 14 of the positive electron beam sensitive resist film 13 of the mask MHR, depending on the density of the patterns around the hole patterns to be formed on the wafer, the widths W4 and W5 of the exposed halftone film 11 around the opening patterns 12a1,12a2 are changed. This makes it possible to carry out optical intensity correction most suited for the state of the hole patterns and brings about OPC effects.

FIG. 45 is an explanatory view of OPC rules upon microfabrication of hole patterns. The size W6 is an opening size of the opening pattern 12a, the size W7 is an opening size of the opening pattern 14 of the electron beam sensitive resist film, the size D1 is a mask sizing amount (distance from the opening pattern 12a to the opening end of the opening pattern 14) and size D2 is a distance to a target opening pattern 12a from another opening pattern 12a proximal thereto. As illustrated in FIG. 45, the distance D2 between each side of the opening pattern 12a and another opening pattern 12a proximal thereto is measured and a bias (size D1) is applied depending on the distance D2. By the effect of this bias, size fluctuations due to the density of hole patterns can be reduced.

(Embodiment 4)

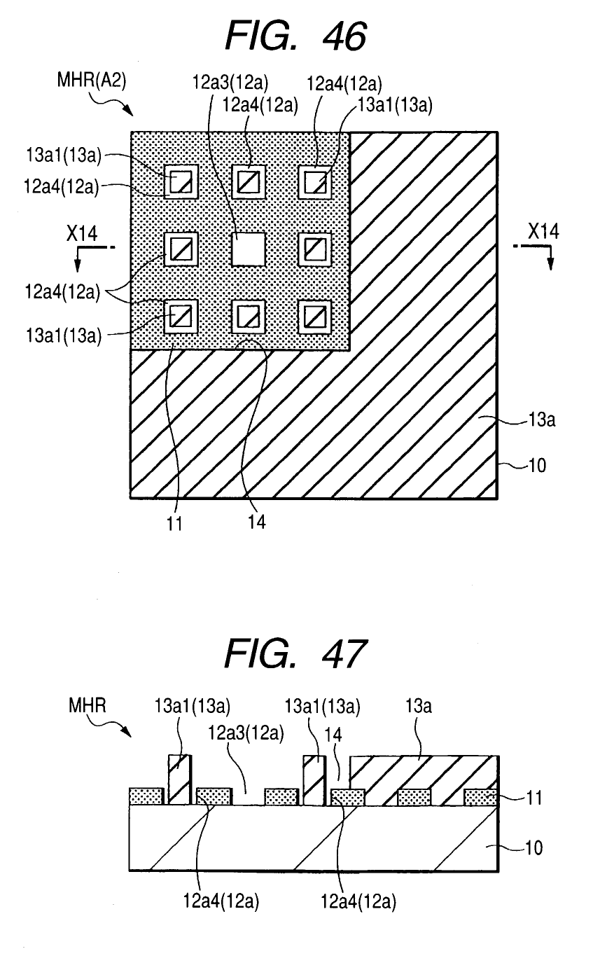

In this Embodiment 4, an application example of OPC to a mask having thereon a negative resist mask will be described. FIG. 46 is an enlarged fragmentary plan view of on application example of OPC in the region A2 of the mask MHR as the one example; and FIG. 47 is a cross-sectional view taken along a line X14-X14 of FIG. 46. An opening pattern 12a3 is a pattern for transferring a hole pattern to a wafer. In this Embodiment 4, desired opening patterns 12a3 and a plurality of opening patterns 12a4 encompassing them are exposed from the opening pattern 14 on the mask MHR. In the opening patterns 12a4 around the desired opening pattern 12a3, a pattern of an electron beam sensitive resist film 13a1 having a planar size smaller than the opening pattern 12a4 is disposed so that the opening patterns 12a4 themselves are not transferred (sensitized) onto a photoresist film on the wafer by exposure treatment. These opening patterns 12a4 have a function as an assistant opening pattern for making up for a shortage of a light which has transmitted through the desired opening patterns 12a3, thereby improving the size accuracy of the hole pattern to be transferred by the opening pattern 12a3. Such a constitution makes it possible to improve the size accuracy of the desired hole pattern to be formed on the wafer.

(Embodiment 5)

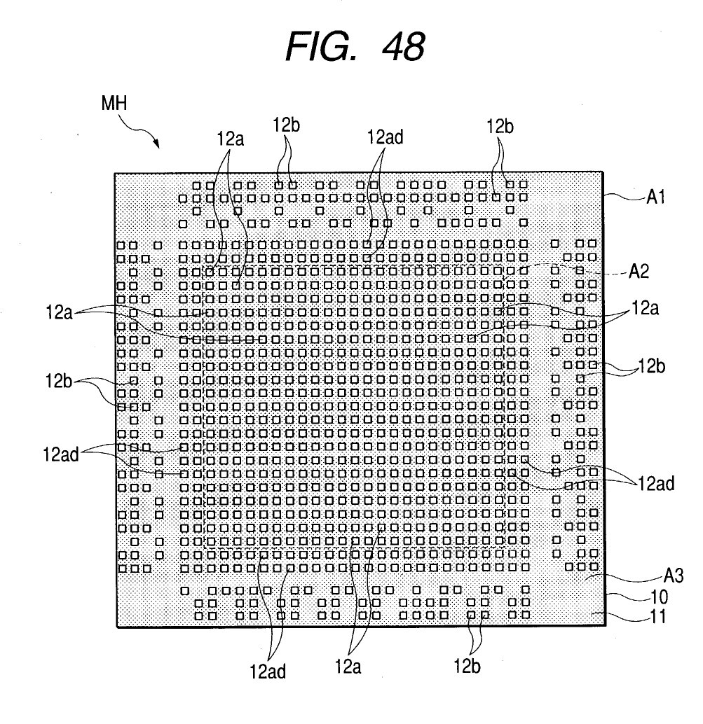

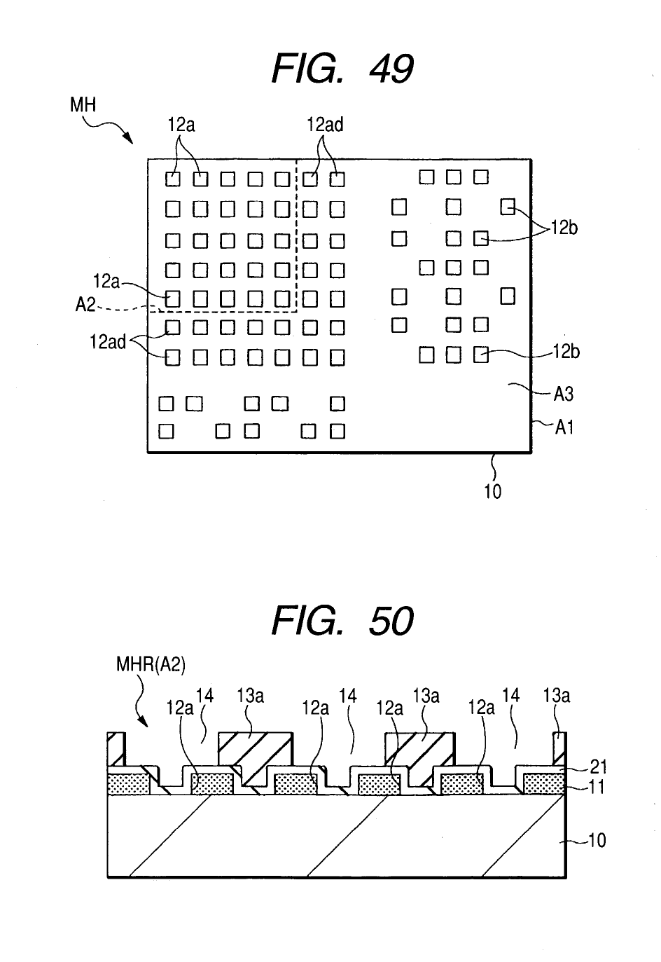

In this Embodiment 5, a modification example of the standard mask will be described with reference to FIGS. 48 and 49. FIG. 48 is a fragmentary plan view of the standard mask MH, and FIG. 49 is an enlarged fragmentary plan view of the standard mask MH of FIG. 48. In this Embodiment 5, dummy opening patterns 12ad are disposed at the periphery of the region A2 of the standard mask MH. By disposing such opening patterns 12ad, the size accuracy of the opening patterns 12a disposed at the outermost periphery of the region A2 can be improved. In addition, by using the opening patterns 2ad as a region for producing OPC effects as described in Embodiment 3 or 4, the size accuracy of the hole patterns to be transferred by the opening patterns 12a at the outermost periphery of the region A2 to a photoresist film on the wafer can be improved.

(Example 6)

In this Embodiment 6, a mask structure having a protective film formed on the surface of a halftone film will be described. FIG. 50 is an enlarged fragmentary cross-sectional view of such a mask MHR. In this Embodiment 6, a protective film 21 is formed, on the first main surface side of the mask MHR to cover patterns of the halftone film 11 and the first main surface of the mask substrate 10 exposed therefrom. The protective film 21 is made of a transparent material such as a silicon oxide film or SOG (Spin On Glass) film formed by sputtering. It is formed so as not to change a light transmittance or phase of a transmitted light. By disposing the protective film 21, the standard mask MH can be protected from the mechanical shock after the standard mask stocking step 105 of FIG. 9. Particularly in the mask MHR of this Embodiment 6, formation of the protective film 21 enables improvement of the durability of the standard mask MH, thereby making it possible to increase the reusing frequency of the standard mask MH.

(Embodiment 7)

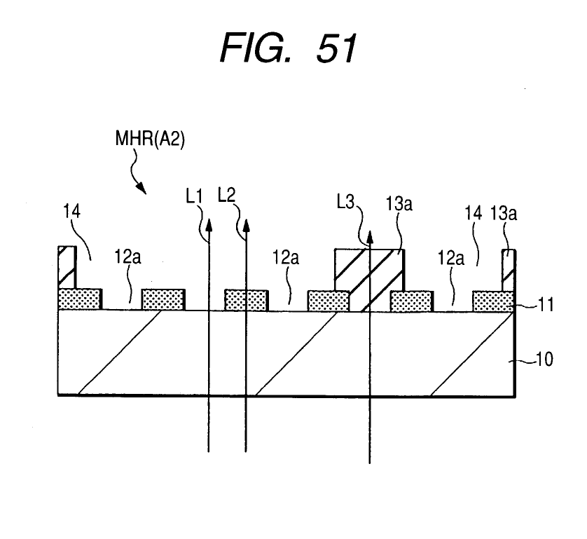

In this Embodiment 7, use of a halftone film for a resist pattern formed over the first main surface of the standard mask with a view to selecting a desired opening pattern of the standard mask will be described. FIG. 51 is an enlarged fragmentary cross-sectional view of the region A2 of a mask MHR of this Embodiment 7. The mask MHR has, formed thereon, a pattern of an electron beam sensitive resist film 13a similar to the masks in Embodiments 1 to 6. The thickness of the electron beam sensitive resist film 13a is however adjusted in this Embodiment 7 so as to make it function as a halftone film. Accordingly, an exposure light L2 which has transmitted through the halftone film 11 of the mask MHR and an exposure light L3 which has transmitted through the electron beam sensitive resist film 13a are adjusted almost equal in phase and light intensity. In this case, size accuracy of hole patterns to be transferred onto the wafer can be improved.

(Embodiment 8)

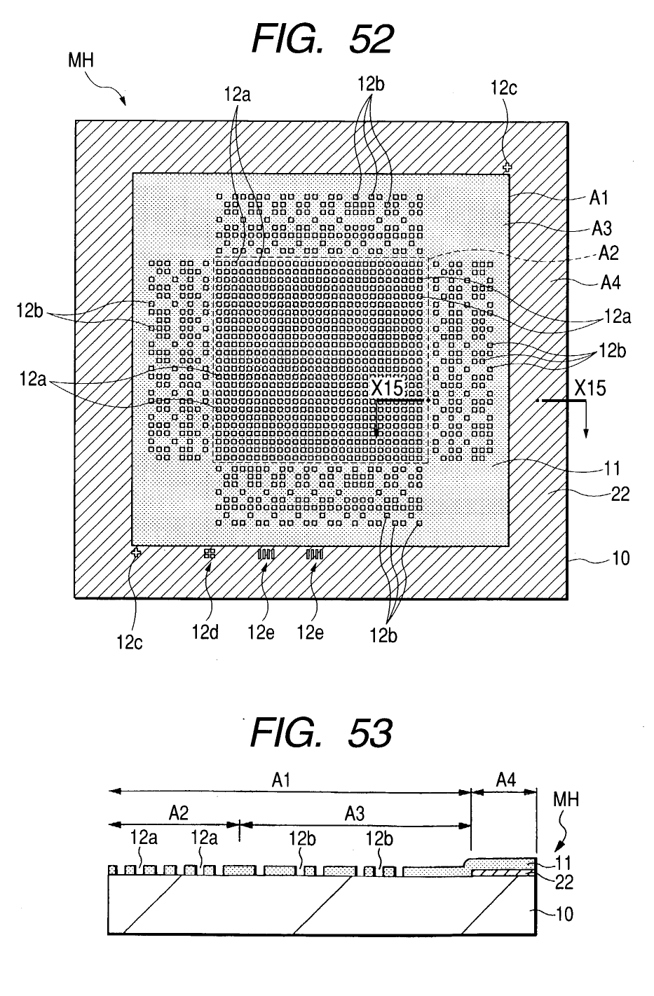

In this Embodiment 8, a structure having a metal frame disposed at the peripheral region of the standard mask will be described. FIG. 52 is an overall plan view illustrating one example of the standard mask MH of Embodiment 8; and FIG. 53 is a cross-sectional view taken along a line X15-X15 of FIG. 52. In this Embodiment 8, a light shielding frame 22 in the planar frame shape is formed in the region A4 on the first main surface of the standard mask MH so as to fringe, with the frame, the periphery of the region A1 for chip transfer. This light shielding frame 22 is made of a metal such as chromium (Cr) and is formed in contact with the first main surface of the mask substrate 10. Some portions of the light shielding frame 22 are removed and there, opening patterns 12c to 12e are formed. In the diagram, the light shielding frame 22 is formed to extend from the periphery of the region A1 to the peripheral end of the standard mask MH but the frame is not limited to it but a narrower frame than that of FIG. 52 may be employed.

(Embodiment 9)

In this Embodiment 9, use of a binary mask as the standard mask will be described. In this case, a plurality of opening patterns 12a to 12e are formed as in Embodiments 1 to 8 by forming a light shielding film instead of the halftone film 11 of the standard mask MH and then forming an opening partially in the light shielding film. This light shielding film may be a metal film such as chromium or a resist film capable of blocking an exposure light. Selection of desired opening patterns 12a is carried out by depositing a resist film capable of blocking an exposure light over the first main surface of the standard mask MH and then patterning it into desired shapes, as in Embodiments 1 to 8.

The present invention made by the present inventors was specifically described based on Embodiments. It should however be born in mind that the present invention is not limited to or by these embodiments and can be modified within an extent not departing from the gist of the invention.

For example, in the above-described Embodiments 1 to 9, the present invention was applied to a change in logic circuit. The method described above in Embodiments can be applied not only to a case where a logic circuit is changed but also, for example, a semiconductor integrated circuit device having ROM, the memory data of which are set (or changed) according to the arrangement of contact holes in the memory cell region. In this case, data of ROM can be changed promptly according to needs so that semiconductor integrated circuit devices having ROM rich in the kind of the memory data can be delivered in a short time.

Application of the present invention made by the present inventors to a CMIS gate array for which the invention has been developed was so far described, but application is not limited thereto but it can be applied to a fabrication method of another semiconductor integrated circuit device, for example, a semiconductor integrated circuit device having a memory circuit such as DRAM (Dynamic Random Access Memory), SRAM (Static Random Access Memory) or flash memory (EEPROM, Electric Erasable Programmable Read Only Memory). It can also be applied to a fabrication method of micromachine or liquid-crystal system. It is particularly effective when applied to a device having a constitution which frequently undergoes a circuit change.

Advantages available by the typical inventions, among the inventions disclosed by the present application, will next be described briefly.

By forming patterns of a desired semiconductor integrated circuit device through reduction projection exposure treatment with a halftone type phase shift mask formed by selectively leaving desired opening patterns, among a plurality of opening patterns formed in a halftone film, by using a pattern of a resist film capable of blocking an exposure light, TAT of the semiconductor integrated circuit device can be reduced, leading to a reduction in the delivery time of it.

1. A fabrication method of a semiconductor integrated circuit device, comprising:
(a) preparing a first mask having a plurality of opening patterns formed in a halftone film which has been deposited over a mask substrate and has a function of reversing the phase of a transmitted light;
(b) preparing over said first mask a second mask which is made of a resist film capable of blocking an exposure light and has a resist pattern formed to expose desired opening patterns, among said plurality of opening patterns of said first mask, and to expose a part of said halftone film at the periphery of said desired opening patterns and to cover the other opening patterns; and
(c) transferring the desired patterns onto a photoresist film over a wafer by reduction projection exposure treatment with said second mask.

2. A fabrication method according to claim 1, wherein said desired opening patterns are patterns for transferring hole patterns onto the resist film over the wafer.

3. A fabrication method according to claim 2, wherein said plurality of opening patterns are disposed, in a first region of said first mask corresponding to the formation region of a logic circuit of said semiconductor integrated circuit device, at positions corresponding to all the lattice intersections of an interconnect channel of said logic circuit.

4. A fabrication method according to claim 3, wherein a plurality of primitive cells are regularly arranged in the formation region of said logic circuit.

5. A fabrication method according to claim 1, wherein said resist film capable of blocking an exposure light is a positive film.

6. A fabrication method according to claim 1, wherein said resist film capable of blocking an exposure light is a halftone film.

7. A fabrication method of a semiconductor integrated circuit device, comprising:
(a) preparing a first mask having a plurality of opening patterns, for transferring hole patterns of said semiconductor integrated circuit device, formed in a halftone film which has, over a first main surface of a mask substrate, a first region for transferring hole patterns in the formation region of a logic circuit of said semiconductor integrated circuit device, has therearound a second region for transferring hole patterns in the formation region of a peripheral circuit of said logic circuit, and has at the periphery thereof a third region not contributing to pattern transfer of said semiconductor integrated circuit device, is deposited over the first main surface of said mask substrate and has a function of reversing the phase of a transmitted light;
(b) preparing over said first mask a second mask which is made of a resist film capable of blocking an exposure light and has a resist pattern formed to expose desired opening patterns, among said plurality of opening patterns of said first mask, and to expose a part of said halftone film around said desired opening patterns and to cover the other opening patterns; and
(c) transferring desired hole patterns onto a photoresist film over a wafer by reduction projection exposure treatment with said second mask.

8. A fabrication method according to claim 7, wherein said plurality of opening patterns in the first region of said first mask are disposed at positions corresponding to all the lattice intersections of an interconnect channel of said logic circuit.

9. A fabrication method according to claim 7, wherein said resist pattern of said second mask is formed in said first region, but in neither said second region nor third region.

10. A fabrication method according to claim 7, wherein a plurality of primitive cells are regularly arranged in the formation region of said logic circuit.

11. A fabrication method according to claim 7, wherein said resist film capable of blocking an exposure light is a positive film.

12. A fabrication method according to claim 7, wherein said resist film capable of blocking an exposure light is a halftone film.

13. A fabrication method of a semiconductor integrated circuit device having, on a semiconductor chip, a formation region of a logic circuit and a formation region of a peripheral circuit thereof, the formation region of said logic circuit having therein a first logic circuit region in which a change in logic is carried out and a second logic circuit region having a predetermined arrangement constitution of circuit patterns, comprising:
(a) preparing a first mask having a plurality of opening patterns, for transferring hole patterns of said semiconductor integrated circuit device, in a halftone film which has, over a first main surface of a mask substrate, a first region for transferring patterns in the formation region of said logic circuit, has therearound a second region for transferring patterns in the formation region of said peripheral circuit, has at the periphery thereof a third region not contributing to pattern transfer of said semiconductor integrated circuit device, and has within said first region a fourth region for transferring patterns of the region of said second logic circuit, is deposited over the first main surface of said mask substrate and has a function of reversing the phase of a transmitted light;
(b) preparing a second mask having, in said first region of said first mask, a resist pattern which is made of a resist film capable of blocking an exposure light and is formed to expose desired opening patterns, among said plurality of opening patterns, and to expose a part of said halftone film around said desired opening patterns and to cover the other opening patterns and having no resist pattern formed in said second, third and fourth regions; and
(c) transferring desired patterns onto a photoresist film over a wafer by reduction projection exposure treatment with said second mask.

14. A fabrication method according to claim 13, wherein in said first region of said first mask except said fourth region, said plurality of opening patterns are disposed at positions corresponding to all the lattice intersections of an interconnect channel of said first logic circuit.

15. A fabrication method according to claim 13, wherein said resist film capable of blocking an exposure light is a positive film.

16. A fabrication method according to claim 13, wherein said resist film capable of blocking an exposure light is a halftone film.

17. A fabrication method of a semiconductor integrated circuit device, comprising:
(a) preparing a first mask having a plurality of opening patterns made in a light shielding film formed over a mask substrate;
(b) preparing over said first mask a second mask which is made of a resist film capable of blocking an exposure light and has patterns formed in such a way to expose desired opening patterns, among the plurality of opening patterns of said first mask, and to cover the other opening patterns; and
(c) transferring desired patterns to a photoresist film over a wafer by reduction projection exposure treatment with said second mask.

18. A fabrication method according to claim 17, wherein said desired opening patterns are patterns for transferring hole patterns to a photoresist film over the wafer.

19. A fabrication method according to claim 18, wherein said plurality of opening patterns are disposed, in the first region of said first mask corresponding to the formation region of a logic circuit of said semiconductor integrated circuit device, at positions corresponding to all the lattice intersections of an interconnect channel of said logic circuit.

20. A fabrication method according to claim 19, wherein a plurality of primitive cells are regularly arranged in the formation region of said logic circuit.

21. A fabrication method according to claim 17, wherein said resist film capable of blocking an exposure light is a positive film.

22. A fabrication method according to claim 17, wherein said resist film capable of blocking an exposure light is a halftone film.
